(19) United States
(12) Patent Application Publication
(10) Pub. No.: US 2026/0012813 A1
(43) Pub. Date: Jan. 8, 2026

(54) Uplink Transmissions with Multiple Beams

(71) Applicant: Ofinno, LLC, Reston, VA (US)

(72) Inventors: Gautham Prasad, Herndon, VA (US); Ali Cagatay Cirik, Chantilly, VA (US); Esmael Hejazi Dinan, McLean, VA (US); Hyoungsuk Jeon, Centreville, VA (US); Hua Zhou, Vienna, VA (US); Nazanin Rastegardoost, McLean, VA (US); Taehun Kim, Fairfax, VA (US)

(73) Assignee: Ofinno, LLC, Reston, VA (US)

(21) Appl. No.: 19/329,083

(22) Filed: Sep. 15, 2025

Related U.S. Application Data
(63) Continuation of application No. PCT/US2024/019850, filed on Mar. 14, 2024.
(60) Provisional application No. 63/451,941, filed on Mar. 14, 2023.

(51) Int. Cl. H04W 16/28; H04B 7/06; H04W 72/21; H04W 74/0833

(52) U.S. Cl. CPC H04W 16/28; H04B 7/06964; H04W 72/21; H04W 74/0833

(57) ABSTRACT

A method can include transmitting, by a wireless device and for a beam failure recovery (BFR) of a cell, a random access preamble with multiple spatial filters. The method can also include receiving a message corresponding to the random access preamble. The message indicates a spatial filter of the multiple spatial filters. The method can further include transmitting, after a number of symbols from completion of the BFR, an uplink signal with the spatial filter indicated by the message.

### CROSS REFERENCE TO RELATED APPLICATIONS

This application is a continuation of International Application No. PCT/US2024/019850, filed Mar. 14, 2024, which claims the benefit of U.S. Provisional Application No. 63/451,941, filed Mar. 14, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 shows an example timing diagram as per an aspect of an embodiment of the present disclosure.

FIG. 18 shows an example resource grid diagram as per an aspect of an embodiment of the present disclosure.

FIG. 19 shows an example timing diagram as per an aspect of an embodiment of the present disclosure.

FIG. 20 shows an example timing diagram of an RA procedure.

FIG. 21 shows an example timing diagram as per an aspect of an embodiment of the present disclosure.

FIG. 22 shows an example timing diagram as per an aspect of an embodiment of the present disclosure.

FIG. 23 shows an example embodiment as per an aspect of an embodiment of the present disclosure.

FIG. 24A shows an example timing diagram as per an aspect of an embodiment of the present disclosure.

FIG. 24B shows an example timing diagram as per an aspect of an embodiment of the present disclosure.

FIG. 24C shows an example timing diagram as per an aspect of an embodiment of the present disclosure.

FIG. 25 shows an example flow diagram as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

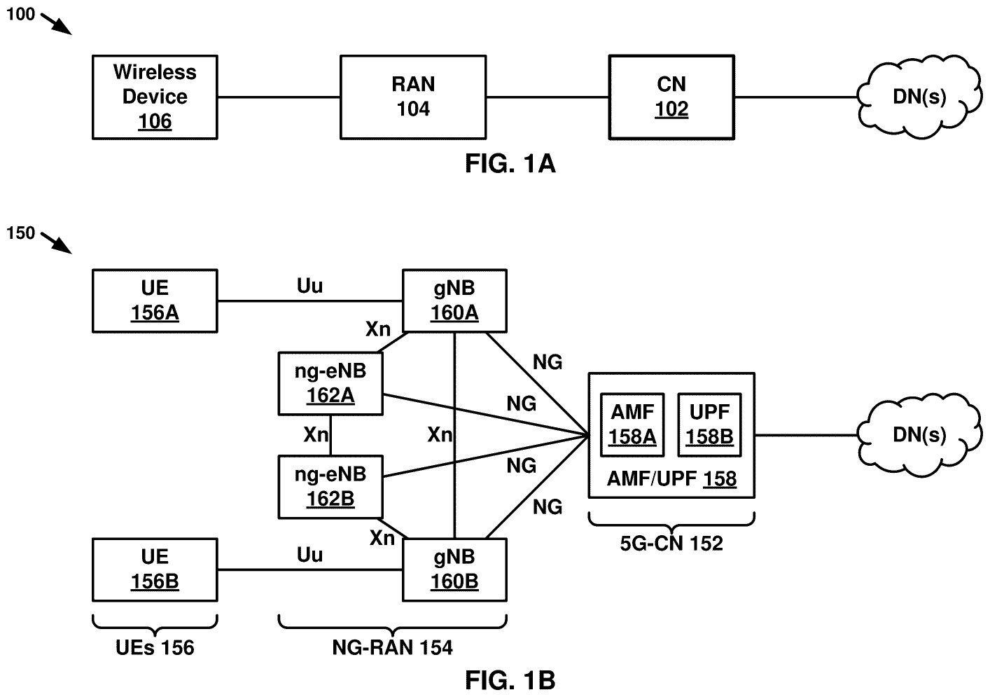

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNS, quality of service (QOS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

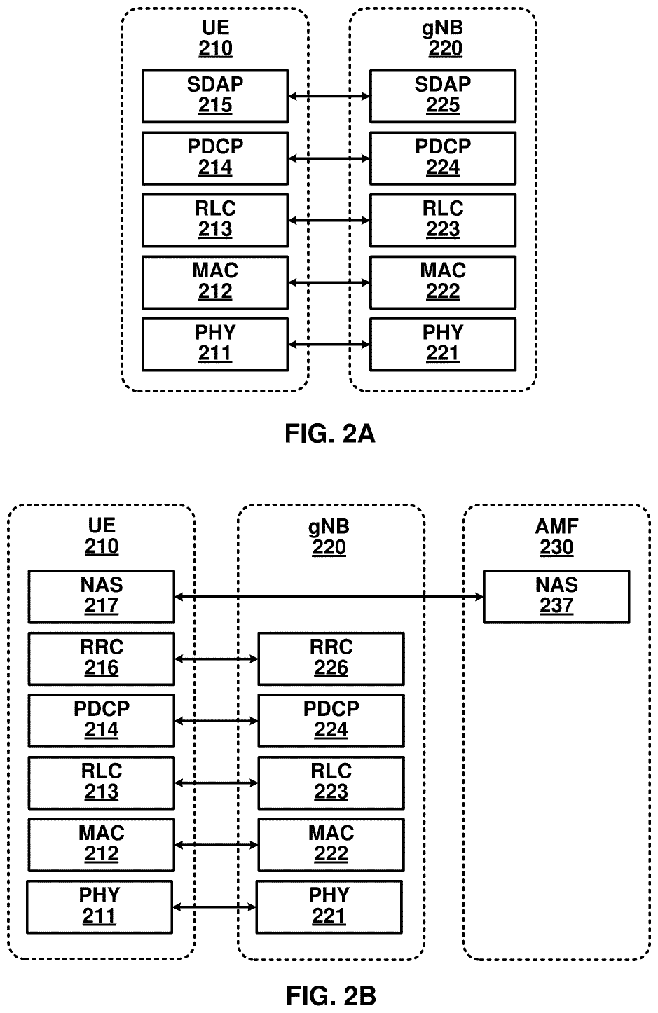

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

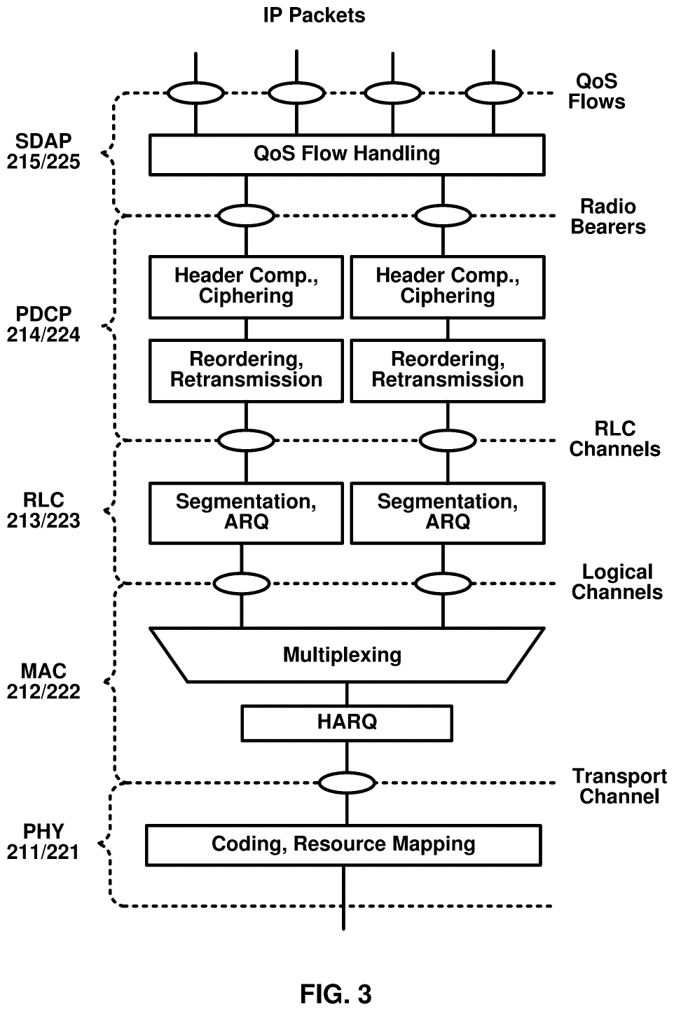

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

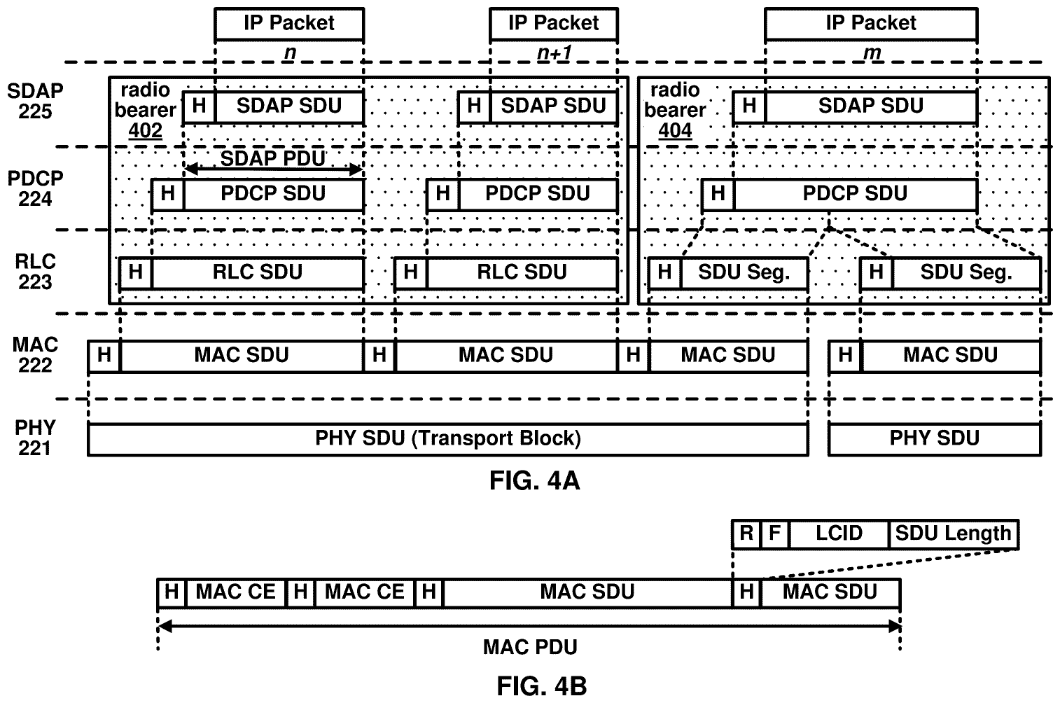

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 212 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

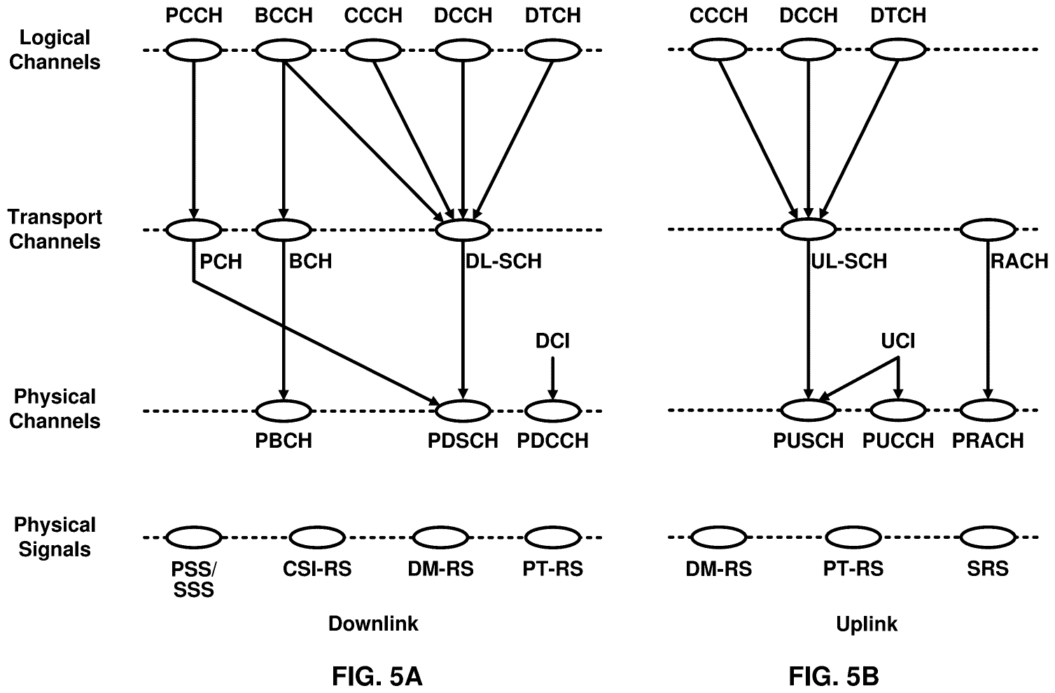

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR includes, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR includes, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR includes, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

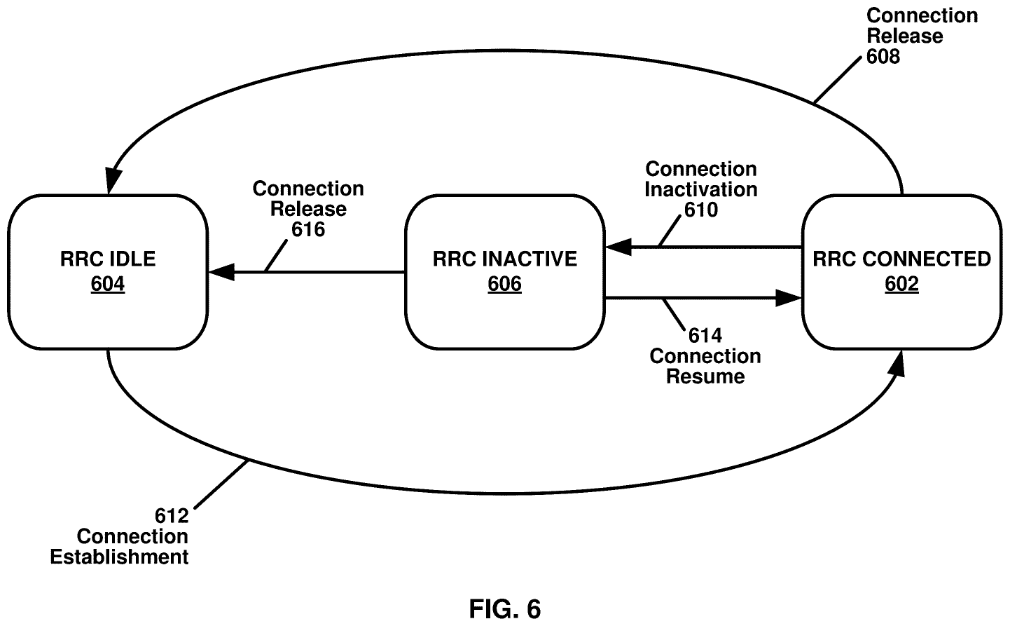

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

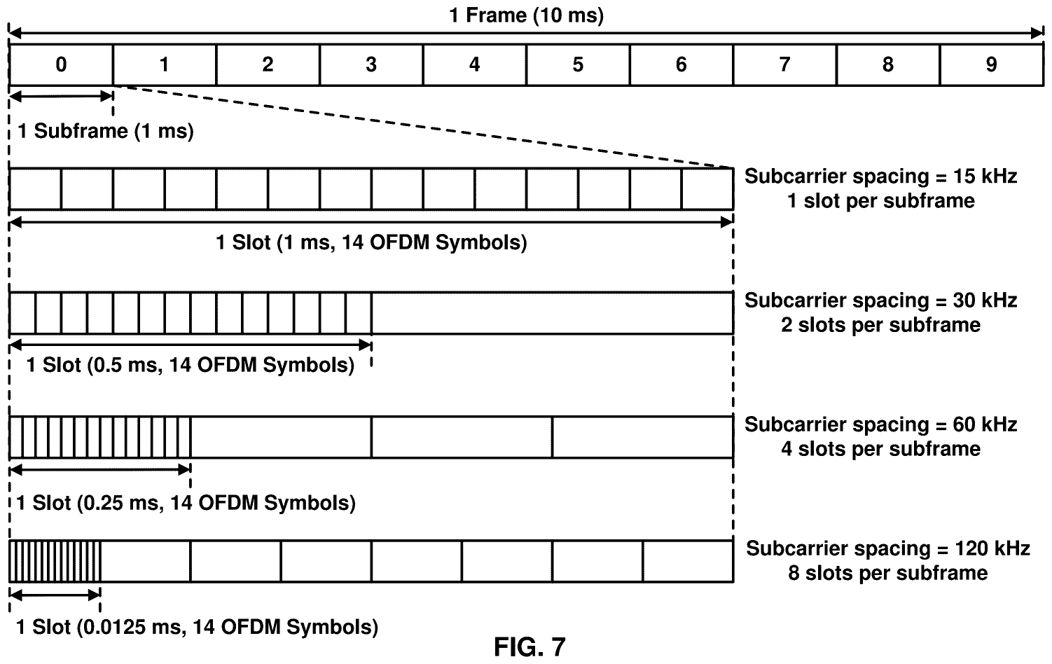

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 KHz/2.3 ρs; 60 KHz/1.2 μs; 120 kHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

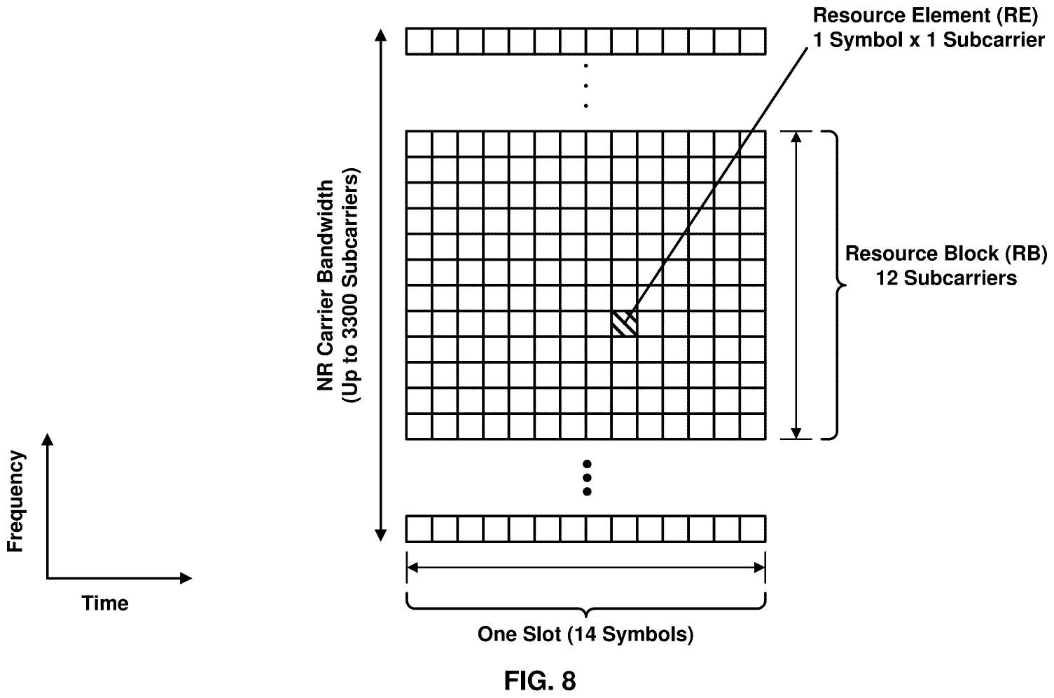

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

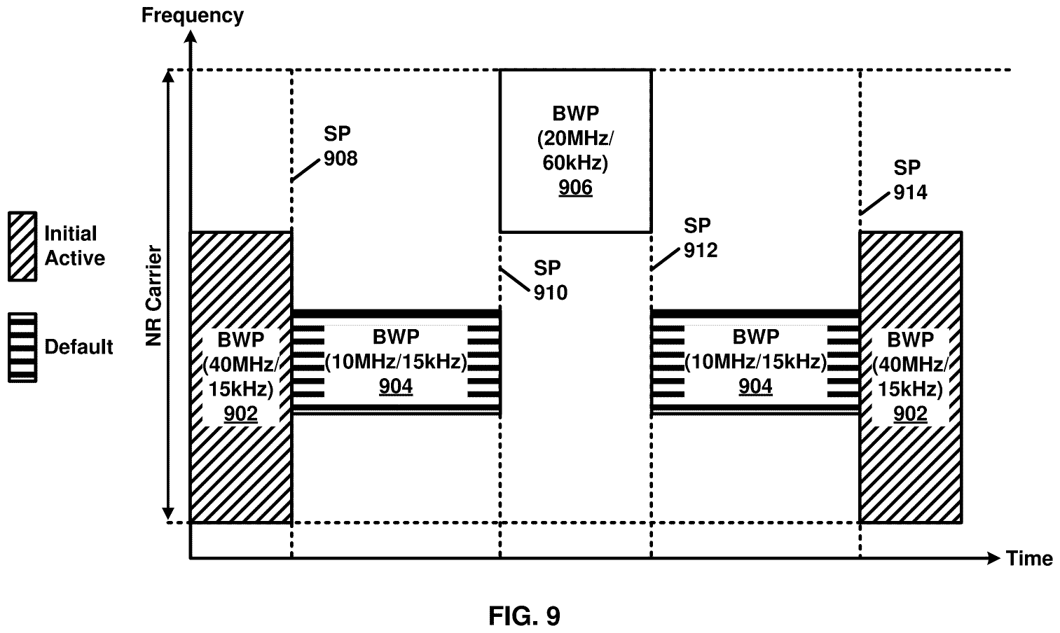

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

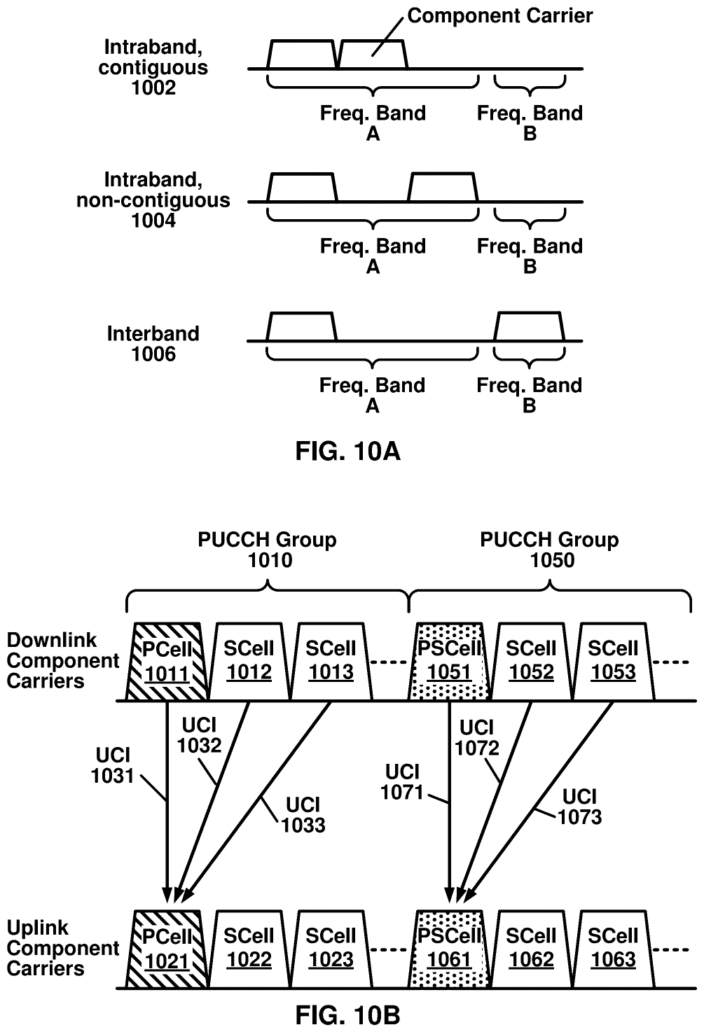

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

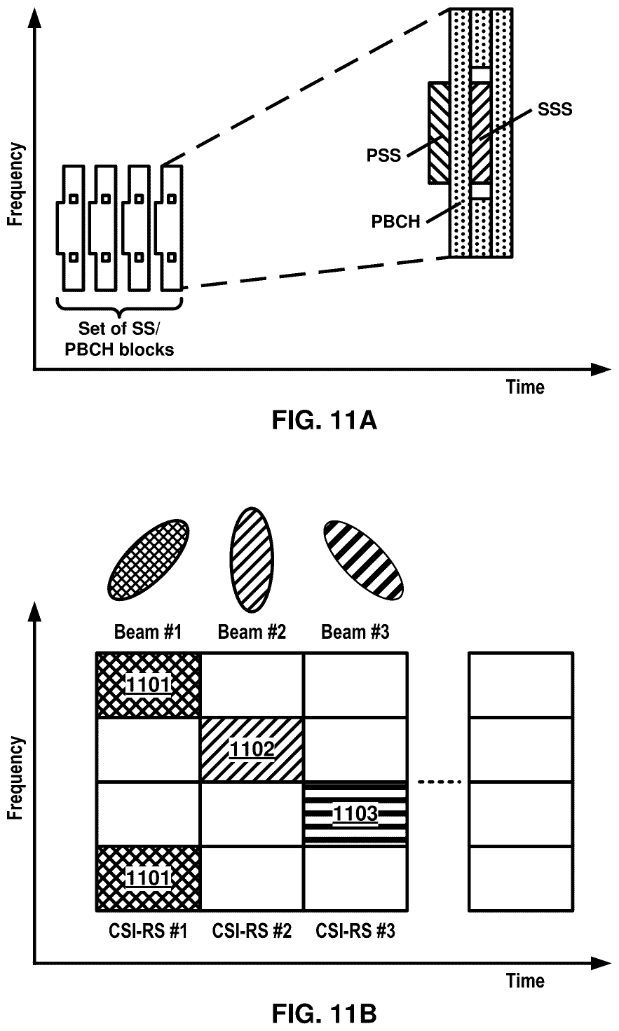

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

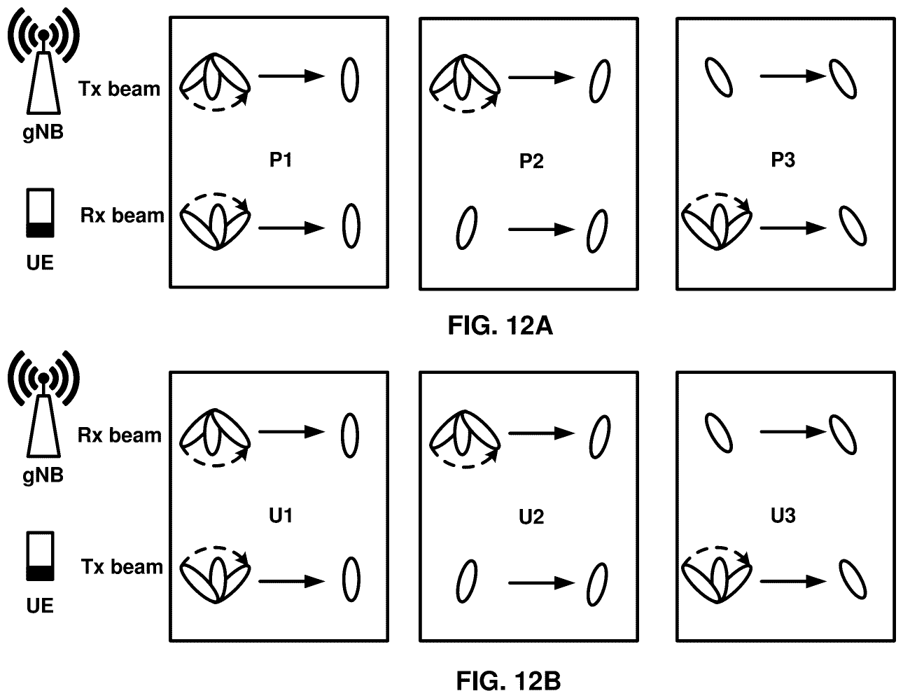

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

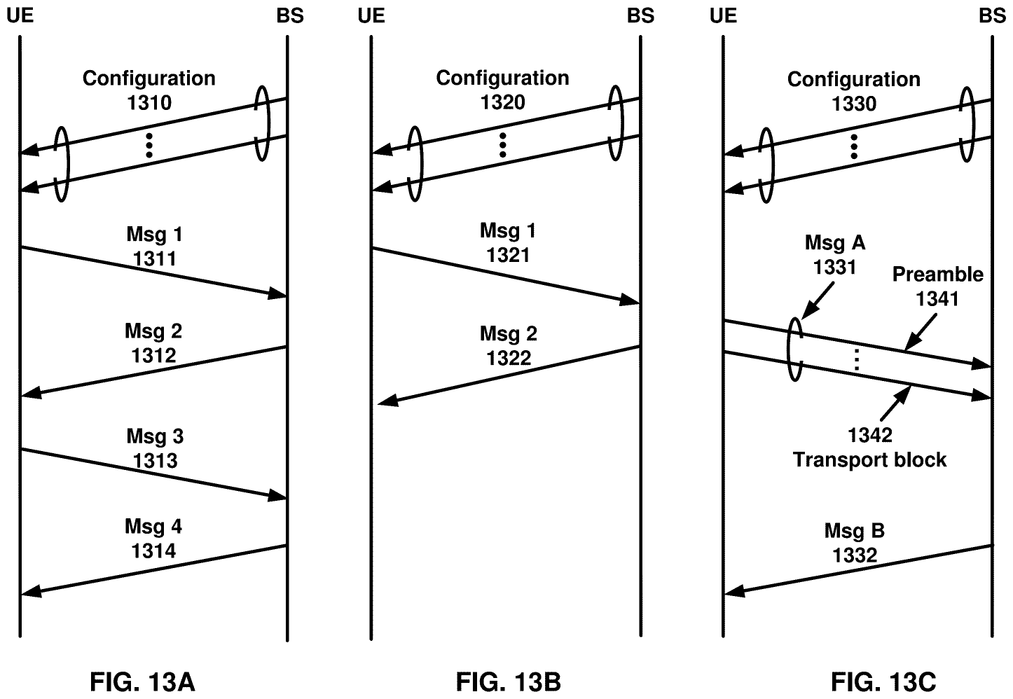

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

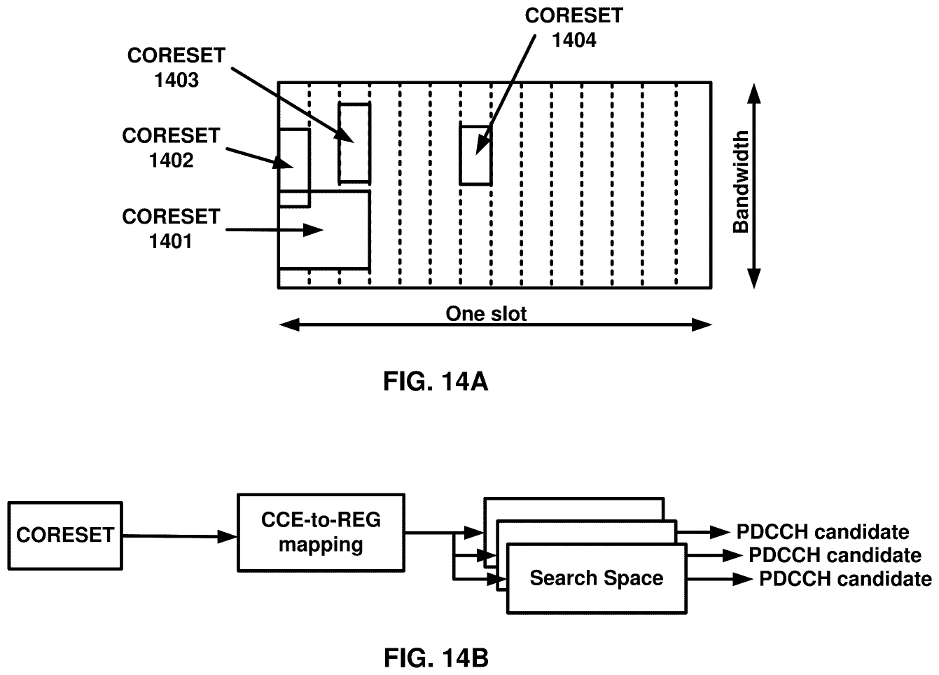

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

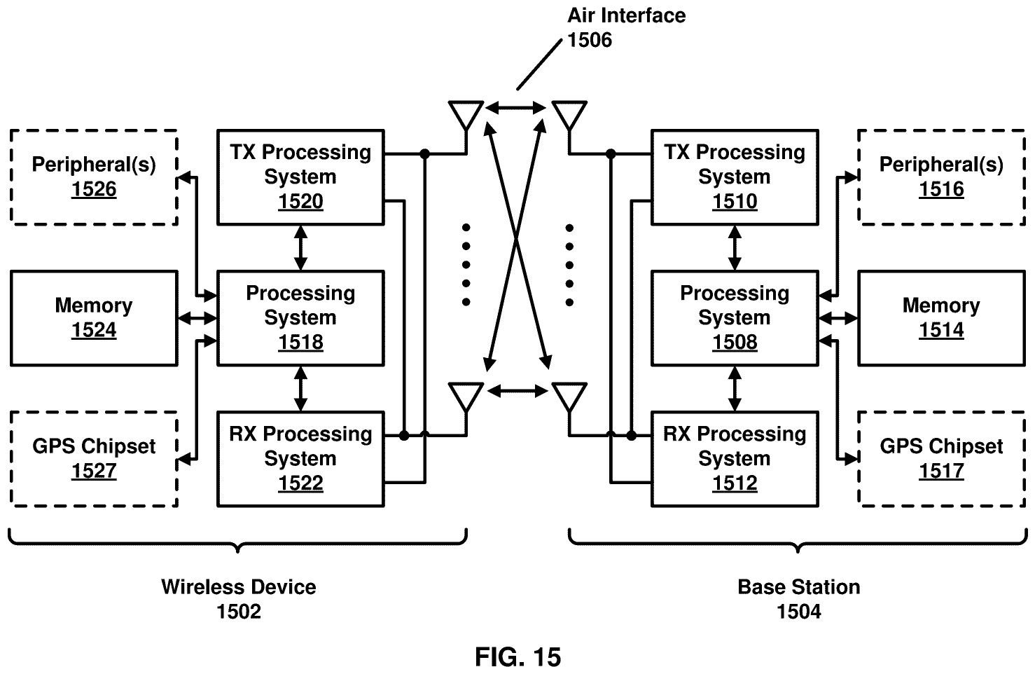

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

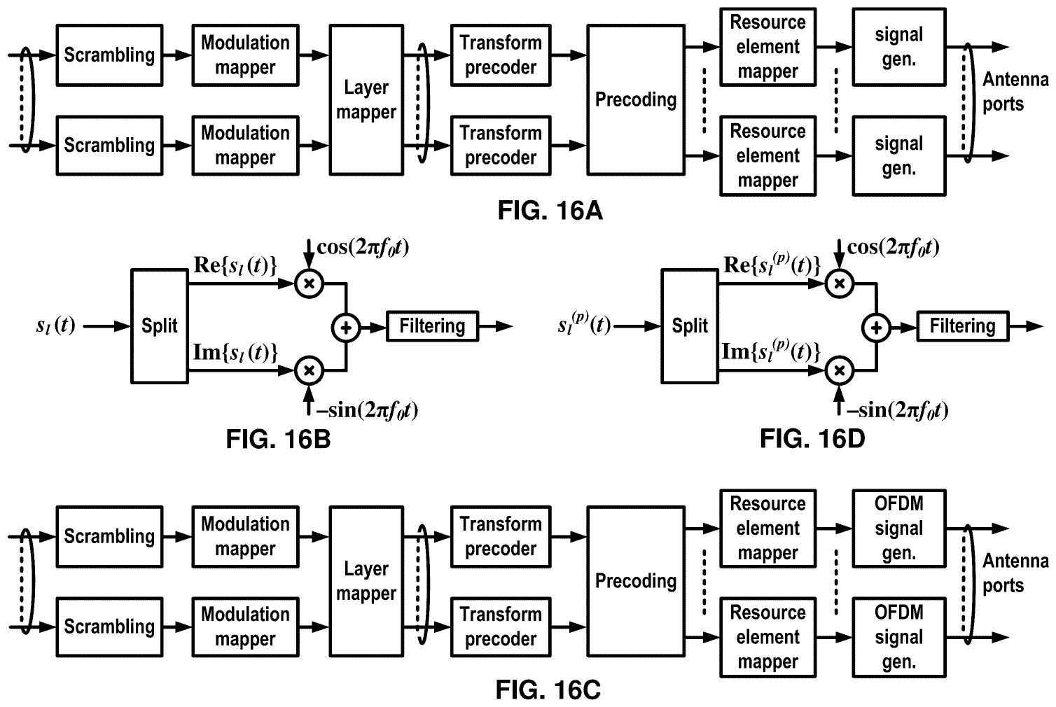

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, and RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

For beam failure detection (BFD), a base station (e.g., gNB, eNB, non-terrestrial network (NTN) payload/node, network, and the like) may configure a wireless device with BFD reference signals (BFD-RSs) (e.g., SSBs, CSI-RSs). The wireless device may declare beam failure when a number of beam failure instance indications from a physical layer (of the wireless device) reaches a configured threshold before a configured timer expires. For BFD in multi-TRP operation, the base station may configure the wireless device with two sets of BFD-RSs. The wireless device may declare beam failure for a TRP/BFD-RS set when the number of beam failure instance (BFI) indications (e.g., BFI_COUNTER) associated with the corresponding set of BFD-RSs from the physical layer (of the wireless device) reaches a configured threshold (e.g., beamFailureInstanceMaxCount) before a configured timer (e.g., beamFailureDetectionTimer) expires.

SSB-based BFD may be based on an SSB associated to an initial DL BWP and may be configured for the initial DL BWPs and for DL BWPs containing the SSB associated to the initial DL BWP. SSB-based BFD may be performed based on non-cell defining SSB, if configured, for RedCap wireless devices. For other DL BWPs, BFD may be performed based on CSI-RS.

After beam failure is detected on a PCell, the wireless device may trigger/initiate a beam failure recovery (BFR) by initiating a Random Access (RA) procedure on the PCell. After beam failure is detected on PCell, the wireless device may select a suitable beam to perform BFR (if the base station has provided dedicated RA resources for certain beams, the dedicated RA resources may be prioritized by the wireless device). After beam failure is detected on PCell, the wireless device may include an indication of a beam failure on PCell in a BFR MAC CE if the RA procedure involves contention-based random access (CBRA).

Upon completion of the RA procedure (e.g., RA procedure initiated for/triggered by the BFR), the BFR for PCell may be (considered) complete.

After beam failure is detected on an SCell, the wireless device may trigger/initiate a BFR by initiating a transmission of a BFR MAC CE for the SCell. After beam failure is detected on an SCell, the wireless device may select a suitable beam for the SCell (if available) and indicate the suitable beam along with information about the beam failure in the BFR MAC CE. Upon reception of a PDCCH indicating an uplink (UL) grant for a new transmission for a HARQ process used for the transmission of the BFR MAC CE, BFR for the SCell may be (considered) complete.

After beam failure is detected for both BFD-RS sets of PCell concurrently, the wireless device may trigger/initiate a BFR by initiating an RA procedure on the PCell. After beam failure is detected for both BFD-RS sets of PCell concurrently, the wireless device may select a suitable beam for each failed BFD-RS set (if available) and indicate whether the suitable (new) beam is found or not along with information about the beam failure in the BFR MAC CE for each failed BFD-RS set. Upon completion of the RA procedure, BFR for both BFD-RS sets of PCell may be (considered) complete.

In an example, a wireless device may receive one or more configuration parameters from a base station. The one or more configuration parameters may indicate or each BWP of a serving cell, a set q̅₀ of periodic CSI-RS resource configuration indexes by failureDetectionResourcesToAddModList and a set q̅₁ of periodic CSI-RS resource configuration indexes and/or SS/PBCH block indexes by candidateBeamRSList or candidateBeamRSListExt or candidateBeamRSSCellList for radio link quality measurements on a BWP of the serving cell. Instead of the sets q̅₀ and q̅₁, for each BWP of a serving cell, the one or more configuration parameters may indicate respective two sets q̅_{0,0} and q̅_{0,1} of periodic CSI-RS resource configuration indexes by failureDetectionSet1 and failureDetectionSet2 that can be activated by a MAC CE and corresponding two sets q̅_{1,0} and q̅_{1,1} of periodic CSI-RS resource configuration indexes and/or SS/PBCH block indexes by candidateBeamRS-List and candidateBeamRS-List2, respectively, for radio link quality measurements on the BWP of the serving cell. The set q̅_{0,0} may be associated with the set q̅_{1,0} and the set q̅_{0,1} may be associated with the set q̅_{1,1}.

A physical layer in the wireless device may assess a radio link quality according to the set q̅₀, q̅_{0,0}, or q̅_{0,1}, of resource configurations against a threshold (e.g., power threshold) Qout,LR. For the set q̅₀, the wireless device may assess the radio link quality according to SS/PBCH blocks (SSBs) on a PCell or a PSCell or periodic CSI-RS resource configurations that are quasi co-located with a DM-RS of PDCCH receptions by the wireless device. The wireless device may apply a Qin, LR threshold to an L1-RSRP measurement obtained from a SS/PBCH block. The wireless device may apply the Qin, LR threshold to an L1-RSRP measurement obtained for a CSI-RS resource after scaling a respective CSI-RS reception power with a value provided by powerControlOffsetSS.

In non-DRX mode operation, the physical layer in the wireless device may provide an indication to higher layers (e.g., upper layer(s), MAC layer(s), MAC entity, RRC layer(s), and the like) when a radio link quality for all corresponding resource configurations in the set q̅₀, or in the set q̅_{0,0} or q̅_{0,1}, that the wireless device uses to assess the radio link quality is worse than the threshold Q_{out,LR}. The physical layer may inform/transmit/indicate to the higher layers when the radio link quality is worse than the threshold Q_{out,LR} with a periodicity determined by the maximum between a shortest periodicity among the SS/PBCH blocks on the PCell or the PSCell and/or the periodic CSI-RS configurations in the set q̅₀, q̅_{0,0}, or q̅_{0,1} that the wireless device uses to assess the radio link quality and 2 msec. In DRX mode operation, the physical layer may provide an indication to higher layers when the radio link quality is worse than the threshold Q_{out,LR} with a second periodicity.

For a PCell or a PSCell, upon request from higher layers, the wireless device may provide to higher layers the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold.

For the SCell, upon request from higher layers, the wireless device may indicate to higher layers whether there is at least one periodic CSI-RS configuration index or SS/PBCH block index from the set q̅₁, or q̅_{1,0}, or q̅_{1,1} with corresponding L1-RSRP measurements that is larger than or equal to the Q_{in,LR} threshold. The wireless device may provide the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold, if any.

For the PCell or the PSCell, the wireless device may be provided (e.g., via the one or more configuration parameters) a CORESET through a link to a search space set provided by recoverySearchSpaceId, for monitoring PDCCH in the CORESET. If the wireless device is provided (e.g., via the one or more configuration parameters) recoverySearchSpaceId, the wireless device may not (expect to) be provided another search space set for monitoring PDCCH in the CORESET associated with the search space set provided by recoverySearchSpaceId.

For the PCell or the PSCell, the wireless device may be provided (e.g., via the one or more configuration parameters), by PRACH-ResourceDedicatedBFR, a configuration for a PRACH transmission. For a PRACH transmission in slot n and according to antenna port quasi co-location parameters associated with periodic CSI-RS resource configuration or with SS/PBCH block associated with index q_{new} provided by higher layers, the wireless device may monitor PDCCH in a search space set provided by recoverySearchSpaceId for detection of a DCI format with CRC scrambled by C-RNTI or MCS-C-RNTI starting from slot n+4+2 [symbol] ·k_{mac}, where μ is the SCS configuration for the PRACH transmission and k_{mac} is a number of slots provided by kmac (e.g., via the one or more configuration parameters) or k_{mac}=0 if kmac is not provided, within a window configured by BeamFailureRecoveryConfig. For PDCCH monitoring in a search space set provided by recoverySearchSpaceId and for corresponding PDSCH receptions, the wireless device may assume/use a same antenna port quasi-collocation parameters as the ones associated with index q_{new} until the wireless device receives by higher layers (or via one or more second configuration parameters) an activation for a TCI state or any of parameters tci-StatesPDCCH-ToAddList and/or tci-StatesPDCCH-ToReleaseList. After the wireless device detects a DCI format with CRC scrambled by C-RNTI or MCS-C-RNTI in the search space set provided by recoverySearchSpaceId, the wireless device may continue to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

For the PCell or the PSCell, after 28 symbols from a last symbol of a first PDCCH reception in a search space set provided by recoverySearchSpaceId for which the wireless device detects a DCI format with CRC scrambled by C-RNTI or MCS-C-RNTI and until the wireless device receives an activation command for PUCCH-SpatialRelationInfo or is provided PUCCH-SpatialRelationInfo for PUCCH resource(s), the wireless device may transmit a PUCCH on a same cell as the PRACH transmission using a same spatial filter as for the last PRACH transmission. For the PCell or the PSCell, after 28 symbols from a last symbol of a first PDCCH reception in a search space set provided by recoverySearchSpaceId for which the wireless device detects a DCI format with CRC scrambled by C-RNTI or MCS-C-RNTI and until the wireless device receives an activation command for PUCCH-SpatialRelationInfo or is provided PUCCH-SpatialRelationInfo for PUCCH resource(s), the wireless device may transmit a PUCCH on a same cell as the PRACH transmission using a power determined with q [symbol] =0, q [symbol] =q_{new}, and l=0.

For the PCell or the PSCell and for sets q̅₀ and q̅₁, after 28 symbols from a last symbol of a first PDCCH reception in a search space set provided by recoverySearchSpaceId where the wireless device detects a DCI format with CRC scrambled by C-RNTI or MCS-C-RNTI, the wireless device may assume/use same antenna port quasi-collocation parameters as the ones associated with index q_{new} for PDCCH monitoring in a CORESET with index 0.

If the wireless device is provided TCI-State_r17 indicating a unified TCI state for the PCell or the PSCell, after 28 symbols from a last symbol of a first PDCCH reception in a search space set provided by recoverySearchSpaceId where the wireless device detects a DCI format with CRC scrambled by C-RNTI or MCS-C-RNTI, the wireless device, if SSB-MTC-AdditionalPCI is not provided, may monitor PDCCH in all CORESETs, and may receive PDSCH and aperiodic CSI-RS resource in a CSI-RS resource set with same indicated TCI state as for the PDCCH and PDSCH, using the same antenna port quasi co-location parameters as the ones associated with the corresponding index q_{new}, if any.

If (or based on, in response to, and the like) the wireless device is provided TCI-State_r17 (e.g., configuration parameter(s) of the one or more configuration parameters) indicating a unified TCI state for the PCell or the PSCell, after 28 symbols from a last symbol of a first PDCCH reception in a search space set provided by recoverySearchSpaceId where the wireless device detects a DCI format with CRC scrambled by C-RNTI or MCS-C-RNTI, the wireless device may transmit PUSCH, PUCCH and SRS that uses a same spatial (domain) filter with same indicated TCI state as for the PUSCH and the PUCCH, using a same spatial (domain) filter as for the last PRACH transmission.

For the PCell or the PSCell, if (or based on, in response to, and the like) a BFR MAC CE is provided in Msg3 or MsgA of contention based random access procedure, and if (or based on, in response to, and the like) a PUCCH resource is provided with PUCCH-SpatialRelationInfo, after 28 symbols from the last symbol of the PDCCH reception that determines the completion of the contention based RA (CBRA) procedure, the wireless device may transmit a PUCCH on a same cell as the PRACH transmission using a same spatial filter as for the last PRACH transmission. For the PCell or the PSCell, if (or based on, in response to, and the like) a BFR MAC CE is provided in Msg3 or MsgA of a CBRA procedure, and if (or based on, in response to, and the like) a PUCCH resource is provided with PUCCH-SpatialRelationInfo, after 28 symbols from the last symbol of the PDCCH reception that determines the completion of the CBRA procedure, the wireless device may transmit a PUCCH on a same cell as the PRACH transmission using a power determined as described in clause 7.2.1 with q [symbol] =0, q [symbol] =q_{new}, and l=0, where q_{new} is the SS/PBCH block index selected for the last PRACH transmission.

If (or in response to, based on, and the like) the wireless device is provided (e.g., via the one or more configuration parameters) dl-OrJoint-TCIStateList or TCI-UL-State indicating a unified TCI state for the PCell or the PSCell and the wireless device provides/transmits/includes BFR MAC CE in Msg3 or MsgA of a CBRA procedure, after 28 symbols from the last symbol of the PDCCH reception that determines the completion of the CBRA procedure, the wireless device, if SSB-MTC-AdditionalPCI is not provided, may monitor PDCCH in all CORESETs, and may receive PDSCH and aperiodic CSI-RS resource in a CSI-RS resource set with same indicated TCI state as for the PDCCH and PDSCH using the same antenna port quasi co-location parameters as the ones associated with the corresponding index q_{new}, if any.

If (or in response to, based on, and the like) the wireless device is provided (e.g., via the one or more configuration parameters) dl-OrJoint-TCIStateList or TCI-UL-State indicating a unified TCI state for the PCell or the PSCell and the wireless device provides/transmits/includes BFR MAC CE in Msg3 or MsgA of a CBRA procedure, after 28 symbols from the last symbol of the PDCCH reception that determines the completion of the CBRA procedure, the wireless device may transmit PUSCH, PUCCH and SRS that uses a same spatial domain filter with same indicated TCI state as for the PUSCH and PUCCH, using a same spatial domain filter as for the last PRACH transmission.

The wireless device (e.g., a MAC entity of the wireless device) may be configured (e.g., via the one or more configuration parameters) per Serving Cell or per BFD-RS set with a BFR (e.g., BFR procedure). The BFR may be used (e.g., by the wireless device) for indicating to the base station (e.g., serving gNB) of a new SSB or CSI-RS when beam failure is detected on the serving SSB(s)/CSI-RS(s). The wireless device may detect a beam failure by counting beam failure instance indication from lower layers (e.g., physical layer of the wireless device, Layer 1 of the wireless device, and the like) to the MAC entity (e.g., the wireless device). If beamFailureRecoveryConfig is reconfigured by upper layers (e.g., RRC layer of the wireless device) during an ongoing Random Access (RA) procedure for BFR for SpCell, the wireless device may stop the ongoing RA procedure and initiate a new RA procedure using the new configuration. When a SCG is deactivated, the wireless device may perform BFD on the PSCell if bfd-and-RLM is set to true (e.g., in the one or more configuration parameters).

The one or more configuration parameters may comprise beamFailureRecoveryConfig, beamFailureRecoverySpCellConfig, beamFailureRecoverySCellConfig and/or the radioLinkMonitoringConfig for a BFD and/or BFR procedure. For example, beam failure detection and recovery procedure may be referred to as BFR procedure.

The one or more configuration parameters may comprise a count (e.g., beamFailureInstanceMaxCount) for a BFD (per Serving Cell or per BFD-RS set of Serving Cell configured with two BFD-RS sets).

The one or more configuration parameters may comprise a detection timer (e.g., beamFailureDetectionTimer) for the BFD (per Serving Cell or per BFD-RS set of Serving Cell configured with two BFD-RS sets).

The one or more configuration parameters may comprise a recovery timer (e.g., beamFailureRecoveryTimer) for a BFR procedure for SpCell. In some embodiments, “BFR” and “BFR procedure” may be used interchangeably (e.g., may mean/indicate the same).

The wireless device may use a counter (e.g., BFI_COUNTER) (per Serving Cell or per BFD-RS set of Serving Cell configured with two BFD-RS sets) to count a number of beam failure instance indication (e.g., indicated by the lower layers of the wireless device). The wireless device may initially set the BFI_COUNTER to 0.

In an example, a serving cell of the wireless device may be configured (e.g., indicated by the one or more configuration parameters) with two BFD-RS sets (e.g., the one or more configuration parameters may indicate two BFD-RS sets for the serving cell). The wireless device (e.g., MAC entity of the wireless device) may receive a beam failure instance indication for a first BFD-RS set of the two BFD-RS sets (e.g., from the lower layers). The wireless device may start or restart the beamFailureDetectionTimer of the first BFD-RS set based on receiving the beam failure instance indication for the first BFD-RS set. The wireless device may increment BFI_COUNTER of the first BFD-RS set by 1, for example, based on receiving the beam failure instance indication for the first BFD-RS set. In an example, the BFI_COUNTER of the first BFD-RS set may be greater than (or equal to) beamFailureInstanceMaxCount. The wireless device may trigger a BFR for the first BFD-RS set of the Serving Cell, for example, based on the BFI_COUNTER of the first BFD-RS set being greater than (or equal to) beamFailureInstanceMaxCount.

In an example, the wireless device may trigger a BFR respectively for each BFD-RS set of the two BFD-RS sets. A BFR procedure may not be successfully completed for any BFD-RS set of the two BFD-RS sets. The wireless device may initiate an RA procedure, e.g., on the SpCell, for example, based on triggering a BFR respectively for each BFD-RS set of the two BFD-RS sets (and/or the beam failure recovery procedure not being successfully completed for any BFD-RS set of the two BFD-RS sets).

In an example, the wireless device may set BFI_COUNTER of each BFD-RS set of SpCell to 0, for example, based on an RA procedure initiated for BFR of both BFD-RS sets of SpCell being successfully completed (and/or the serving cell being the SpCell). The wireless device may determine (e.g., consider) the BFR procedure to be successfully completed, for example, based on the RA procedure initiated for the BFR of both BFD-RS sets of SpCell being successfully completed (and/or the serving cell being the SpCell).

In an example, the detection timer of a first BFD-RS set may expire. The wireless device may set BFI_COUNTER of the first BFD-RS set to 0, for example, based on the detection timer of the first BFD-RS set expiring. In an example, the beamFailureDetectionTimer, beamFailureInstanceMaxCount, or any of the reference signals used for BFD may be reconfigured by upper layers or by the BFD-RS Indication MAC CE associated with the first BFD-RS set of the Serving Cell. The wireless device may set BFI_COUNTER of the first BFD-RS set to 0, for example, based on the beamFailureDetectionTimer, beamFailureInstanceMaxCount, or any of the reference signals used for BFD being reconfigured by upper layers or by the BFD-RS Indication MAC CE associated with the first BFD-RS set of the Serving Cell.

In an example, a PDCCH addressed to C-RNTI indicating uplink grant for a new transmission may be received by the wireless device for a HARQ process used for a transmission of an Enhanced BFR MAC CE or a Truncated Enhanced BFR MAC CE comprising beam failure recovery information of a first BFD-RS set of the Serving Cell. The wireless device may set BFI_COUNTER of the first BFD-RS set to 0 based on receiving the PDCCH addressed to C-RNTI indicating uplink grant for a new transmission for the HARQ process used for the transmission of the Enhanced BFR MAC CE or the Truncated Enhanced BFR MAC CE comprising beam failure recovery information of the first BFD-RS set of the Serving Cell. The wireless device may consider the BFR procedure successfully completed for the first BFD-RS set and/or cancel all the triggered BFRs of the first BFD-RS set of the Serving Cell based on receiving the PDCCH addressed to C-RNTI indicating uplink grant for a new transmission for the HARQ process used for the transmission of the Enhanced BFR MAC CE or the Truncated Enhanced BFR MAC CE comprising BFR information of the first BFD-RS set of the Serving Cell.

In an example, the serving cell may be an SCell. The one or more configuration parameters may indicate deactivation of the SCell. The wireless device may set BFI_COUNTER of each BFD-RS set of the two BFD-RS Sets of the SCell to 0 based on the one or more configuration parameters indicating deactivation of the SCell. The wireless device may determine (e.g., consider) the BFR procedure to be successfully completed and/or cancel all the triggered BFRs of all BFD-RS sets of the Serving Cell based on the one or more configuration parameters indicating deactivation of the SCell.

In an example, the Serving Cell may configured with a (single) BFD-RS set (e.g., the one or more configuration parameters may indicate the (single) BFD-RS set for the serving cell, the one or more configuration parameters may not indicate a second BFD-RS set for the serving cell other than the (single) BFD-RS set, and the like). In an example, the wireless device (e.g., MAC entity of the wireless device) may receive beam failure instance indication from the lower layers. The wireless device (e.g., lower layers of the wireless device, physical layer of the wireless device, Layer-1 of the wireless device, and the like) may determine a beam failure instance, for example, based on a radio link quality (e.g., Layer-1 reference signal received power (L1-RSRP), block error rate (BLER), signal power, and the like) of a reference signal (RS) being below a power threshold. The one or more configuration parameters may, for example, indicate the power threshold.

The wireless device may start or restart the beamFailureDetectionTimer based on receiving the beam failure instance indication. The wireless device may increment the BFI_COUNTER by 1 based on receiving the beam failure instance indication.

In an example, the BFI_COUNTER may be greater than or equal to beamFailureInstanceMaxCount.

In an example, the serving cell may be an SCell. The wireless device may trigger a BFR for the serving cell based on the serving cell being an SCell and the BFI_COUNTER being greater than or equal to beamFailureInstanceMaxCount.

In an example, the serving cell may be a PSCell. The wireless device may indicate beam failure of the PSCell to upper layers (e.g., RRC layer of the wireless device) based on the serving cell being a PSCell, the SCG being deactivated, BFI_COUNTER being greater than or equal to beamFailureInstanceMaxCount, and/or beam failure of the PSCell not being indicated to upper layers since the SCG was deactivated and/or since the deactivated SCG was last reconfigured with BFD-RS.

In an example, the serving cell may be a PCell. The wireless device may initiate an RA procedure on a SpCell (e.g., PCell, serving cell), for example, for BFR, based on the BFI_COUNTER being greater than or equal to beamFailureInstanceMaxCount (and/or the serving cell being a PCell).

The wireless device may set the BFI_COUNTER to 0 based on an expiry of the detection timer. The wireless device may set the BFI_COUNTER to 0 based on beamFailureDetectionTimer, beamFailureInstanceMaxCount, and/or any of the reference signals used for beam failure detection being reconfigured by upper layers associated with the Serving Cell.

In an example, the RA procedure initiated for BFR (e.g., on the SpCell) may be successfully completed. The wireless device may set the BFI_COUNTER to 0 based on the RA procedure initiated for BFR (e.g., on the SpCell) being successfully completed. The wireless device may stop the recovery timer (e.g., beamFailureRecoveryTimer) based on the RA procedure initiated for BFR (e.g., on the SpCell) being successfully completed. The wireless device may consider the BFR procedure to be successfully completed based on the RA procedure initiated for BFR (e.g., on the SpCell) being successfully completed.

In an example, the serving cell may be an SCell. The wireless device may receive a PDCCH addressed to C-RNTI indicating uplink grant for a new transmission for a HARQ process used for a transmission of a MAC CE for BFR which contains BFR information of the Serving Cell. The wireless device may set the BFI_COUNTER to 0 based on the serving cell being an SCell and/or the wireless device receiving a PDCCH addressed to C-RNTI indicating uplink grant for the new transmission for the HARQ process used for the transmission of the MAC CE for BFR which contains BFR information of the Serving Cell. The wireless device may consider the BFR procedure successfully completed and/or cancel all the triggered BFRs for the Serving Cell based on the serving cell being an SCell and/or the wireless device receiving a PDCCH addressed to C-RNTI indicating uplink grant for the new transmission for the HARQ process used for the transmission of the MAC CE for BFR which contains BFR information of the Serving Cell.

In an example, the one or more configuration parameters may indicate deactivation of the SCell. The wireless device may set the BFI_COUNTER to 0 based on receiving the one or more configuration parameters indicating deactivation of the SCell. The wireless device may consider the BFR procedure successfully completed and/or cancel all the triggered BFRs for the Serving Cell based on receiving the one or more configuration parameters indicating deactivation of the SCell.

The MAC entity may: if the BFR procedure determines that at least one BFR has been triggered and not cancelled for an SCell for which evaluation of the candidate beams has been completed and if none of the Serving Cell(s) of this MAC entity are configured with two BFD-RS sets: if UL-SCH resources are available for a new transmission and if the UL-SCH resources can accommodate the BFR MAC CE plus its subheader as a result of LCP: instruct the Multiplexing and Assembly procedure to generate the BFR MAC CE. Else if UL-SCH resources are available for a new transmission and if the UL-SCH resources can accommodate the Truncated BFR MAC CE plus its subheader as a result of LCP: instruct the Multiplexing and Assembly procedure to generate the Truncated BFR MAC CE. Else: trigger an SR for SCell beam failure recovery for each SCell for which BFR has been triggered, not cancelled, and for which evaluation of the candidate beams has been completed.

If the BFR procedure determines that at least one BFR for any BFD-RS set has been triggered and not cancelled for an SCell for which evaluation of the candidate beams has been completed; or
if the BFR procedure determines that at least one BFR for only one BFD-RS set has been triggered and not cancelled for an SpCell for which evaluation of the candidate beams has been completed; or
if the BFR procedure determines that at least one BFR has been triggered and not cancelled for an SCell for which evaluation of the candidate beams has been completed and if at least one Serving Cell of this MAC entity is configured with two BFD-RS sets:
if UL-SCH resources are available for a new transmission and if the UL-SCH resources can accommodate the Enhanced BFR MAC CE plus its subheader as a result of LCP:
instruct the Multiplexing and Assembly procedure to generate the Enhanced BFR MAC CE. Else if UL-SCH resources are available for a new transmission and if the UL-SCH resources can accommodate the Truncated Enhanced BFR MAC CE plus its subheader as a result of LCP: instruct the Multiplexing and Assembly procedure to generate the Truncated Enhanced BFR MAC CE. Else: trigger the SR for beam failure recovery of each BFD-RS set for which BFR has been triggered, not cancelled, and for which evaluation of the candidate beams has been completed; trigger the SR for SCell beam failure recovery for each SCell for which BFR has been triggered, not cancelled, and for which evaluation of the candidate beams has been completed.

All BFRs triggered for an SCell may be cancelled by the wireless device when a MAC PDU is transmitted and the MAC PDU includes a MAC CE for BFR which contains beam failure information of the SCell. All BFRs triggered for a BFD-RS set of a Serving Cell may be cancelled by the wireless device when a MAC PDU is transmitted and the MAC PDU includes an Enhanced BFR MAC CE or Truncated Enhanced BFR MAC CE which contains BFR information of the BFD-RS set of the Serving Cell.

In existing technologies, a wireless device may initiate an RA procedure, for example, for (or as part of) BFR (e.g., BFR procedure). The wireless device transmits/performs a PRACH transmission (e.g., RA preamble), for the RA procedure, using/with a first spatial filter. The wireless device may receive a downlink (DL) message (e.g., PDCCH reception in a search space set provided by recoverySearchSpaceId where the wireless device detects a DCI format with CRC scrambled by C-RNTI or MCS-C-RNTI, PDCCH reception that determines completion of a contention based random access (CBRA) procedure, and the like). After a time gap (e.g., 28 symbols) from receiving the DL message, the wireless device may transmit an uplink (UL) message (e.g., PUCCH, PUSCH, SRS, and the like) using a spatial filter used for the last PRACH transmission (e.g., the first spatial filter, based on using the first spatial filter for the PRACH transmission).

The wireless device, of existing technologies, may initiate/perform an RA procedure, for example, for BFR. In an example, the wireless device may transmit/perform a plurality of PRACH transmissions (e.g., one or more repetitions (each) of one or more RA preambles), for the RA procedure, using/with a plurality of spatial filters (e.g., for coverage enhancement, to reduce latency, for beam refinement, and the like). For example, the plurality of PRACH transmissions (e.g., RA preambles) may comprise a first PRACH transmission. The plurality of PRACH transmissions may comprise a second PRACH transmission. The plurality of spatial filters may comprise a first spatial filter. The plurality of spatial filters may comprise a second spatial filter. The wireless device may transmit/perform the first PRACH transmission (e.g., first RA preamble) using the first spatial filter. The wireless device may transmit/perform, e.g., after the first PRACH transmission, the second PRACH transmission (e.g., second RA preamble) using the second spatial filter. The wireless device may receive a DL message (e.g., PDCCH reception in a search space set provided by recoverySearchSpaceId where the wireless device detects a DCI format with CRC scrambled by C-RNTI or MCS-C-RNTI, PDCCH reception that determines completion of a contention based random access (CBRA) procedure (e.g., Msg4), and the like), from a base station, after (or in response to/based on) the plurality of PRACH transmissions. According to the implementation of existing technologies, the wireless device may use a spatial filter used for a last PRACH transmission (e.g., the second spatial filter that was used for the second PRACH transmission) to transmit an UL message/signal (e.g., PUCCH, PUSCH, SRS, and the like) after the time gap (e.g., 28 symbols) from the DL message. The second PRACH transmission using the second spatial filter, for example, may not reach (e.g., may not be decoded by) a base station. For example, the base station may transmit the DL message in response to receiving (and/or decoding) the first PRACH transmission (e.g., and not (receiving/decoding) the second PRACH transmission). The second spatial filter may be, for example, not suitable (e.g., optimal, best, ideal, workable, and the like) for UL and/or DL communication between the wireless device and the base station. Transmitting the UL message/signal (e.g., PUCCH, PUSCH, SRS, and the like) using the spatial filter that was used for a last preamble/PRACH transmission (e.g., the second spatial filter) may result in undesirable consequences, e.g., unnecessary (additional/further) beam failures (or BFDs), increase in power consumption at the wireless device and/or the base station, reduction in battery life of the wireless device, increase in (network access) latency, underutilization of UL/DL resources, and/or reduction in throughput.

In an example describing the implementation of the existing technologies, the wireless device may not know which spatial filter, of the plurality of spatial filters used for the plurality of PRACH transmissions, to use for (subsequent) UL and/or DL communication. Using a wrong spatial filter for UL and/or DL communications may result in the undesirable consequences.

In another example of the implementation of the existing technologies, a wireless device may transmit/perform a plurality of PRACH transmissions (e.g., RA preambles) using/with a plurality of spatial filters for a contention based RA (CBRA) procedure. In response to the plurality of PRACH transmissions, the wireless device may receive a DL message (e.g., Msg2). The DL message may indicate a spatial filter. The wireless device may use the spatial filter for an UL transmission (e.g., Msg3) before/prior to a completion of the CBRA procedure. In an example, the CBRA procedure may not complete successfully (e.g., due to unsuccessful contention resolution). For example, the spatial filter indicated by/in the DL message may be (intended) for a second wireless device. As a result, the wireless device may use an incorrect spatial filter for UL transmission(s). Using an incorrect spatial filter for UL transmission(s) may lead to unnecessary (additional/further) beam failures (or BFDs), increase in power consumption at the wireless device and/or the base station, reduction in battery life of the wireless device, increase in (network access) latency, underutilization of UL/DL resources, and/or reduction in throughput.

In light of the existing technologies, there is a need to improve determining spatial filter(s) (e.g., default spatial filter(s) for UL and/or DL communication (e.g., transmission(s) and/or reception(s) after/during beam failure detection/recovery.

According to an example embodiment, a wireless device may transmit/perform a plurality of PRACH transmissions (e.g., one or more repetitions (each) of one or more RA preambles) with/using a plurality of spatial filters. The plurality of PRACH transmissions may comprise a first PRACH transmission and a second PRACH transmission. The plurality of spatial filters may comprise a first spatial filter and a second spatial filter. The wireless device may transmit/perform the first PRACH transmission (e.g., a first RA preamble) using the first spatial filter. The wireless device may transmit/perform, e.g., after the first PRACH transmission, the second PRACH transmission (e.g., a second RA preamble) using the second spatial filter. The first PRACH transmission and the second PRACH transmission may be for an RA procedure. The RA procedure may be initiated (e.g., by the wireless device) for BFR (e.g., BFR procedure). In response to the first and/or the second PRACH transmission, the wireless device may receive a DL message (e.g., PDCCH reception in a search space set provided by recoverySearchSpaceId where the wireless device detects a DCI format with CRC scrambled by C-RNTI or MCS-C-RNTI, PDCCH reception that determines completion of the RA procedure (e.g., CBRA procedure), and the like). The DL message may indicate a spatial filter, of the plurality of spatial filters, e.g., as a default spatial filter. The wireless device may use the spatial filter (e.g., the default spatial filter) to transmit and/or receive one or more DL/UL signals (e.g., PUCCH transmission), for example, until the wireless device receives an activation command indicating a different spatial filter. The wireless device may use the different spatial filter for UL/DL transmission(s) after receiving the activation command. The wireless device may use the spatial filter (e.g., the default spatial filter) to transmit and/or receive the one or more DL/UL signals, for example, after a number of symbols after completing the BFR/RA procedure. The wireless device may not use the spatial filter (e.g., the default spatial filter) to transmit and/or receive the one or more DL/UL signals, for example, before a completion of the BFR/RA procedure (or before the number of symbols after the completion of the BFR/RA procedure).

Based on using the spatial filter indicated by the DL message (e.g., instead of using a spatial filter used for a last PRACH transmission) for a UL transmission, the base station may receive (e.g., successfully receive, decode, and the like) the UL transmission (e.g., since the base station indicated the spatial filter, for example, based on receiving a PRACH transmission (e.g., a first PRACH transmission, a second PRACH transmission, a PRACH transmission of the plurality of PRACH transmissions) that used the spatial filter). Based on using the spatial filter indicated by the DL message (e.g., instead of using a spatial filter used for a last PRACH transmission) for the UL transmission, the wireless device may reduce a number of beam failure instances and/or a number of performing BFR procedures (e.g., based on the indication of the spatial filter in the DL message (also) indicating that the spatial filter is suitable for UL/DL communication between the wireless device and the base station). Based on using the spatial filter indicated by the DL message (e.g., instead of using a spatial filter used for a last PRACH transmission) for the UL transmission, (only) after a number of symbols after a completion of the BFR (or the RA procedure initiated for BFR), the wireless device may not set/use an incorrect/suboptimal spatial filter for the UL transmission. As a result, power consumption in the wireless device and/or the base station may be reduced, battery life of the wireless device may be improved, underutilization of UL/DL resources may be reduced, and throughput may be increased.

In an example embodiment according to the present disclosure, a wireless device may receive one or more messages. In an example, the wireless device may receive the one or more messages from a base station. The base station may transmit the one or more messages. The one or more messages may comprise one or more configuration parameters. In an example, the one or more configuration parameters may be/comprise one or more RRC configuration parameters. In an example, the one or more configuration parameters may be/comprise one or more RRC reconfiguration parameter(s). In an example, the one or more configuration parameters may be/comprise one or more RRC release parameters. In an example, the one or more configuration parameters may be/comprise one or more system information parameters (e.g., system information block (SIB), MIB, and like).

In an example, the one or more configuration parameters may be for one or more cells.

The one or more cells may comprise a cell. In an example, at least one configuration parameter of the one or more configuration parameters may be for the cell. In an example, the cell may be a primary cell (PCell). In an example, the cell may be a secondary cell (SCell). In an example, the cell may be a Special Cell (SpCell). The cell may be a secondary cell configured with PUCCH (e.g., PUCCH SCell). In an example, the cell may be an unlicensed cell, e.g., operating in an unlicensed band (shared spectrum channel access). In an example, the cell may be a licensed cell, e.g., operating in a licensed band. In an example, the cell may operate in a first frequency range (FR1). The FR1 may, for example, comprise frequency bands below 6 GHZ. In an example, the cell may operate in a second frequency range (FR2). The FR2 may, for example, comprise frequency bands from 24 GHz to 52.6 GHz. In an example, the cell may operate in a third frequency range (FR3). The FR3 may, for example, comprise frequency bands from 52.6 GHz to 71 GHz. The FR3 may, for example, comprise frequency bands starting from 52.6 GHz. The cell may be, for example, a non-terrestrial network (NTN) cell. The cell may be, for example, part of a master cell group (MCG). The cell may be, for example, part of a secondary cell group (SCG). The base station may, for example, serve the cell. The base station may, for example, transmit the one or more messages to a plurality of wireless devices in the cell. The cell may be a serving cell, e.g., of/for the wireless device. The cell may be a non-serving cell, e.g., of/for the wireless device.

In an example, the wireless device may perform uplink transmissions (e.g., PRACH, PUSCH, PUCCH, SRS, and the like) via the cell in a first time and in a first frequency. The wireless device may perform downlink receptions (e.g., PDCCH, PDSCH) via the cell in a second time and in a second frequency. In an example, the cell may operate in a time-division duplex (TDD) mode. In the TDD mode, the first frequency and the second frequency may be the same. In the TDD mode, the first time and the second time may be different. In an example, the cell may operate in a frequency-division duplex (FDD) mode. In the FDD mode, the first frequency and the second frequency may be different. In the FDD mode, the first time and the second time may be the same.

In an example, the wireless device may be in an RRC connected mode. In an example, the wireless device may be in an RRC idle mode. In an example, the wireless device may be in an RRC inactive mode.

In an example, the cell may comprise a plurality of bandwidth parts (BWPs). The plurality of BWPs may comprise one or more uplink BWPs comprising an uplink BWP of the cell. The plurality of BWPs may comprise one or more downlink BWPs comprising a downlink BWP of the cell.

In an example, a BWP of the plurality of BWPs may be in one of an active state and an inactive state. In an example, in the active state of a downlink BWP of the one or more downlink BWPs, the wireless device may monitor a downlink channel/signal (e.g., PDCCH, DCI, CSI-RS, PDSCH) on/for/via the downlink BWP. In an example, in the active state of a downlink BWP of the one or more downlink BWPs, the wireless device may receive a PDSCH on/via/for the downlink BWP. In an example, in the inactive state of a downlink BWP of the one or more downlink BWPs, the wireless device may not monitor a downlink channel/signal (e.g., PDCCH, DCI, CSI-RS, PDSCH) on/via/for the downlink BWP. In the inactive state of a downlink BWP of the one or more downlink BWPs, the wireless device may stop monitoring (or receiving) a downlink channel/signal (e.g., PDCCH, DCI, CSI-RS, PDSCH) on/via/for the downlink BWP. In an example, in the inactive state of a downlink BWP of the one or more downlink BWPs, the wireless device may not receive a PDSCH on/via/for the downlink BWP. In the inactive state of a downlink BWP of the one or more downlink BWPs, the wireless device may stop receiving a PDSCH on/via/for the downlink BWP.

In an example, the cell may be a serving cell of the wireless device.

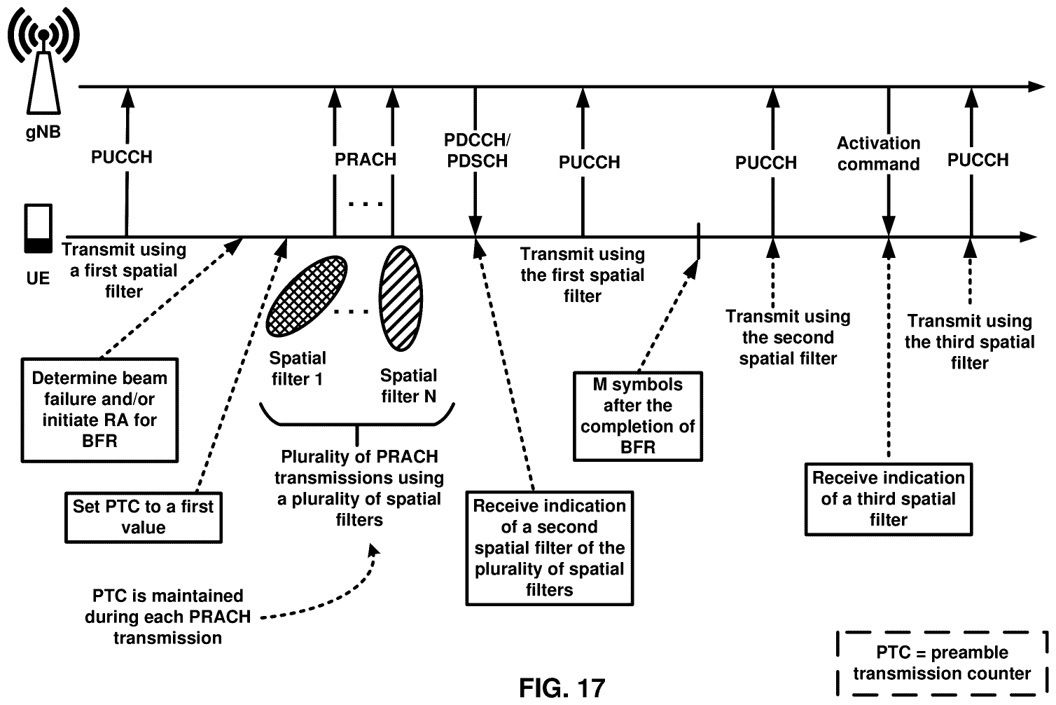

FIG. 17 shows an example timing diagram as per an aspect of an embodiment of the present disclosure. According to the example of FIG. 17, the wireless device may transmit a first UL signal/message (e.g., PUCCH, PUSCH, SRS, and the like) via/using/with a first spatial filter. The wireless device may transmit the first UL signal/message via first UL resource(s) (e.g., PUCCH resource(s), SRS resource(s), PUSCH resource(s), and the like) of the cell. The one or more configuration parameters may, for example, indicate the first UL resource(s). The one or more configuration parameters may indicate a plurality of UL resources (e.g., plurality of PUCCH resources, plurality of SRS resources, plurality of PUSCH resources, and the like). The plurality of UL resources may comprise the first UL resource(s). The one or more configuration parameters may indicate the first UL resource(s), of the plurality of UL resources, for example, based on/using/via a UL resource indicator (e.g., PUCCH resource indicator (PRI), SRS resource indicator (SRI), and the like). In an example, the wireless device may receive a DL message (e.g., DCI, PDCCH, and the like) that comprises/indicates the UL resource indicator. The one or more configuration parameters may indicate/comprise/configure one or more UL resource sets (e.g., PUCCH resource set). The one or more UL resource sets may comprise the first UL resource and/or the plurality of UL resources. The one or more configuration parameters may indicate, for the first UL resource(s), the first spatial filter (e.g., a spatial relation, spatial information, and the like). The one or more configuration parameters may indicate, for each UL resource of the plurality of UL resources, a spatial filter.

The wireless device may, for example, determine a beam failure (e.g., after transmitting the first UL signal/message). The wireless device may perform a BFR (e.g., BFR procedure, RA for BFR, and the like). The wireless device may determine to perform the BFR, for example, based on a number of beam failure instances (or beam failure instance indications) exceeding a threshold (e.g., beamFailureInstanceMaxCount). The one or more configuration parameters may, for example, indicate the threshold. The wireless device may determine to perform the BFR, for example, based on a number of beam failure instances (or beam failure instance indications) exceeding a threshold.

The wireless device may determine a beam failure instance, for example, based on a radio link quality (e.g., block error rate (BLER), reference signal received power (RSRP), reference signal received quality (RSRQ), received signal strength indicator/indication (RSSI), signal to noise ratio (SNR), received power, signal strength, power strength, power value, signal quality, channel quality, and the like) of an RS (e.g., an RS from a BFD-RS set) being lower (e.g., less, weaker, poorer, smaller, below, and the like) than a first threshold (or greater than/higher than/equal to the first threshold). The one or more configuration parameters may indicate the first threshold.

The wireless device may initiate/perform an RA procedure, for example, for the BFR. The wireless device may initiate/perform the RA procedure, for example, based on the number of beam failure instances (or beam failure instance indications) exceeding (e.g., being greater than or equal to) the threshold. The wireless device may initiate an RA procedure, for example, based on triggering/initiating the BFR. The wireless device may initiate/perform the RA procedure, for example, in/via/of/for the cell.

The wireless device may transmit/perform a plurality of PRACH transmissions (e.g., one or more repetitions (each) of one or more RA preambles) for the RA procedure (or as part of the RA procedure). The wireless device may transmit/perform the plurality of PRACH transmissions via/using/with a plurality of spatial filters. In the example of FIG. 17, the plurality of spatial filters may comprise Spatial filter 1. The plurality of spatial filters may comprise Spatial filter N (e.g., as shown in FIG. 17). The plurality of spatial filters may comprise N spatial filters (N=2, 4, 8, 16, and the like). In an example, the plurality of spatial filters may comprise the first spatial filter (e.g., used to transmit the first UL signal/message (e.g., PUCCH, PUSCH, SRS) via/using the first UL resource(s), as shown in FIG. 17). In an example, the plurality of spatial filters may not comprise the first spatial filter.

The plurality of PRACH transmissions may comprise a first PRACH transmission. The plurality of PRACH transmissions may comprise a second PRACH transmission. The plurality of PRACH transmissions may comprise K PRACH transmissions (K=1, 2, 4, 8, 16, and the like). K may be, for example, less (e.g., lower, smaller, weaker, poorer, below, and the like) than N. K may be, for example, greater (e.g., higher, more, above, larger, and the like) than N. K may be, for example, equal to N.

The wireless device may transmit/perform the first PRACH transmission using/with/via Spatial filter 1. The wireless device may transmit/perform the second PRACH transmission using/with/via Spatial filter N (e.g., as shown in FIG. 17).

The wireless device may receive a DL message. The wireless device may receive the DL message, for example, based on/in response to transmitting/performing the plurality of PRACH transmissions. The wireless device may receive the DL message, for example, based on/in response to transmitting/performing one or more PRACH transmissions of the plurality of PRACH transmissions.

In an example, the DL message may be/comprise a PDCCH. The wireless device may receive the PDCCH in a search space set indicated by the one or more configuration parameters. The one or more configuration parameters may comprise/indicate recoverySearchSpaceId that indicates the search space set. The DL message may comprise a downlink control information (DCI). The DCI may be associated with a cyclic redundancy check (CRC) scrambled by cell-radio network temporary identifier (C-RNTI), modulation and coding scheme C-RNTI (MCS-C-RNTI), temporary C-RNTI (TC-RNTI), and/or RA-RNTI.

In an example, the DL message may be/comprise a PDCCH. The wireless device may start/restart a contention resolution timer (e.g., ra-ContentionResolutionTimer) prior to receiving the DL message. In an example, the wireless device may receive the DL message when the contention resolution timer is running (e.g., before the contention resolution timer expires, without the contention resolution timer expiring, and the like). In an example, the DL message may be addressed to the C-RNTI. In an example, the wireless device may consider a contention resolution to be successful based on receiving the DL message (e.g., when the contention resolution timer is/was running). The wireless device may, for example, stop the contention resolution timer based on receiving the DL message (e.g., when the contention resolution timer is/was running). The wireless device may consider the RA procedure to be successfully completed, for example, based on receiving the DL message (e.g., when the contention resolution timer is/was running). The wireless device may consider the BFR (or BFR procedure) to be successfully completed, for example, based on receiving the DL message (e.g., when the contention resolution timer is/was running).

In an example, the DL message may be an RA response (RAR). The DL message may be, for example, Msg4. The DL message may be, for example, MsgB. The DL message may be, for example, Msg2. The DL message may be, for example, DCI, PDCCH, and the like.

In the example of FIG. 17, the DL message may indicate a second spatial filter of the plurality of spatial filters. For example, the DL message may indicate Spatial filter 1 (e.g., Spatial filter 1 may be the second spatial filter). In the example of FIG. 17, a reception of the DL message may indicate a (successful) completion of the RA procedure (and/or the BFR). The wireless device may transmit a second UL signal/message (e.g., PUCCH, PUSCH, SRS, PRACH, and the like) with/using the first spatial filter. The wireless device may transmit the second UL signal/message with/using the first spatial filter and not the second spatial filter (e.g., Spatial filter 1). The wireless device may transmit the second UL signal/message with/using the first spatial filter, for example, despite the DL message indicating the second spatial filter. The wireless device may not transmit an (e.g., any) UL signal/message using/with the second spatial filter, for example, until M (M=14, 28, 42, and the like) symbols (or equivalent/corresponding time, e.g., 1 ms, 2 ms, 3 ms, and the like) after the (successful) completion of the RA procedure (and/or the BFR). The wireless device may transmit the second UL signal/message (and/or one or more UL signals/messages) using/with/via the first spatial filter before M symbols after the (successful) completion of the RA procedure (and/or the BFR).

The wireless device may transmit the second UL signal/message via/using/over the first UL resource(s).

The wireless device may determine a spatial filter to transmit the second UL signal/message, for example, based on the plurality of spatial filters, the DL message, a time interval during which the second UL signal/message is transmitted (e.g., before the completion of BFR, after the completion of BFR, after M symbols after the completion of the RA procedure/BFR, and the like), and/or the first UL resource(s) used for transmitting the second UL signal/message being before or after M symbols after the completion of the RA procedure/BFR.

In an example, the DL message may indicate the second spatial filter (e.g., Spatial filter 1) implicitly.

In an example, the plurality of PRACH transmissions may comprise (transmissions of) a plurality of RA preambles. Each RA preamble of the plurality of RA preambles may be different from each other. For example, the plurality of RA preambles may comprise a first RA preamble. The plurality of RA preambles may comprise a second RA preamble. The first RA preamble may be associated with a first preamble index (e.g., PREAMBLE_INDEX, RA preamble identity (RAPID), and the like). The second RA preamble may be associated with a second preamble index. The first preamble index and the second preamble index may be different (e.g., not the same, may not match, and the like). In an example, the first preamble index and the second preamble index may be the same. The wireless device may transmit the first RA preamble using/with, for example, Spatial filter 1. The wireless device may transmit the second RA preamble using/with, for example, Spatial filter N.

In an example embodiment, the DL message may indicate (e.g., comprise, parsed, be associated with) the first preamble index. The DL message may, for example, comprise a MAC subPDU with a preamble index corresponding to the first preamble index. The DL message may indicate Spatial filter 1, for example, based on the DL message indicating the first preamble index (and/or the DL message comprising a MAC subPDU with a preamble index corresponding to the first preamble index). The DL message may indicate Spatial filter 1, for example, based on the DL message indicating the first preamble index (and/or the DL message comprising a MAC subPDU with a preamble index corresponding to the first preamble index) and/or the wireless device transmitting the first RA preamble/PRACH transmission (that is associated with the first preamble index) using/with Spatial filter 1.

In an example, the DL message may indicate (e.g., comprise, parsed, be associated with) the second preamble index. The DL message may, for example, comprise a MAC subPDU with a preamble index corresponding to the second preamble index. The DL message may indicate Spatial filter N, for example, based on the DL message indicating the second preamble index (and/or the DL message comprising a MAC subPDU with a preamble index corresponding to the second preamble index). The DL message may indicate Spatial filter N, for example, based on the DL message indicating the second preamble index (and/or the DL message comprising a MAC subPDU with a preamble index corresponding to the second preamble index) and/or the wireless device transmitting the second RA preamble/PRACH transmission (that is associated with the second preamble index) using/with Spatial filter N.

In an example embodiment, the plurality of PRACH transmissions may comprise a first PRACH transmission (e.g., a first RA preamble). The plurality of PRACH transmissions may comprise a second PRACH transmission (e.g., the first RA preamble, a second RA preamble, and the like). The wireless device may transmit/perform the first PRACH transmission with/using/comprising/indicating/associated with a first RA-RNTI. The wireless device may transmit/perform the second PRACH transmission with/using/comprising/indicating/associated with a second RA-RNTI.

In an example, the DL message may indicate the first RA-RNTI. For example, the DL message may comprise a valid DL assignment on a PDCCH for the first RA-RNTI. The DL message may be, for example, an RAR identified by the first RA-RNTI. The DL message may indicate Spatial filter 1, for example, based on the DL message indicating the first RA-RNTI (e.g., based on the DL message comprising the valid DL assignment on the PDCCH for the first RA-RNTI, the DL message comprising the RAR identified by the first RA-RNTI). The DL message may indicate Spatial filter 1, for example, based on the DL message indicating the first RA-RNTI (e.g., based on the DL message comprising the valid DL assignment on the PDCCH for the first RA-RNTI, the DL message comprising the RAR identified by the first RA-RNTI) and/or the wireless device transmitting the first PRACH transmission (that is associated with the first RA-RNTI) using/with Spatial filter 1.

In an example, the DL message may indicate the second RA-RNTI. For example, the DL message may comprise a valid DL assignment on a PDCCH for the second RA-RNTI. The DL message may be, for example, an RAR identified by the second RA-RNTI. The DL message may indicate Spatial filter N, for example, based on the DL message indicating the second RA-RNTI (e.g., based on the DL message comprising the valid DL assignment on the PDCCH for the second RA-RNTI, the DL message comprising the RAR identified by the second RA-RNTI). The DL message may indicate Spatial filter N, for example, based on the DL message indicating the second RA-RNTI (e.g., based on the DL message comprising the valid DL assignment on the PDCCH for the second RA-RNTI, the DL message comprising the RAR identified by the second RA-RNTI) and/or the wireless device transmitting the second PRACH transmission (that is associated with the second RA-RNTI) using/with Spatial filter N.

In an example embodiment, the plurality of PRACH transmissions may comprise a first PRACH transmission (e.g., a first RA preamble). The plurality of PRACH transmissions may comprise a second PRACH transmission (e.g., the first RA preamble, a second RA preamble, and the like). The wireless device may transmit/perform the first PRACH transmission on/via/using a first RA resource (e.g., first RACH/RA occasion). The wireless device may transmit/perform the second PRACH transmission on/via/using a second RA resource (e.g., second RACH/RA occasion).

In an example, the DL message may indicate the first RA resource (e.g., the first RACH occasion). For example, the DL message may comprise a field indicating an index/identity/identifier that identifies the first RA resource. For example, the field may indicate a first RACH occasion (RO) index. The first RO index may indicate/identify the first RA resource (e.g., the first RACH occasion). The DL message may indicate Spatial filter 1, for example, based on the DL message indicating the first RA resource (e.g., based on the DL message comprising the field indicating the index/identity/identifier that identifies the first RA resource). The DL message may indicate Spatial filter 1, for example, based on the DL message indicating the first RA resource (e.g., based on the DL message comprising the field indicating the index/identity/identifier that identifies the first RA resource) and/or the wireless device transmitting the first PRACH transmission on/via/using the first RA resource using/with Spatial filter 1.

In an example, the DL message may indicate the second RA resource (e.g., the second RACH occasion). For example, the DL message may comprise a field indicating an index/identity/identifier that identifies the second RA resource. For example, the field may indicate a second RACH occasion (RO) index. The second RO index may indicate/identify the second RA resource (e.g., the second RACH occasion). The DL message may indicate Spatial filter N, for example, based on the DL message indicating the second RA resource (e.g., based on the DL message comprising the field indicating the index/identity/identifier that identifies the second RA resource). The DL message may indicate Spatial filter N, for example, based on the DL message indicating the second RA resource (e.g., based on the DL message comprising the field indicating the index/identity/identifier that identifies the second RA resource) and/or the wireless device transmitting the second PRACH transmission on/via/using the first RA resource using/with Spatial filter N.

In an example, the DL message may comprise a plurality of commands (e.g., a plurality of MAC CEs, plurality of RARs, a plurality of PDSCH signals, a plurality of DCIs, and the like). Each command of the plurality of commands may indicate a respective spatial filter of the plurality of spatial filters. For example, the plurality of commands may comprise a first command and a second command. The wireless device may receive the second command after (e.g., later in time) the first command. The first command may indicate Spatial filter N. The second command may indicate Spatial filter 1. The wireless device may determine a spatial filter for the second UL signal/message, for example, based on the second (or last) command. The DL message may indicate Spatial filter 1 (e.g., the second spatial filter may be Spatial filter 1), for example, based on the second (or last) command indicating Spatial filter 1.

After M symbols after the completion of the BFR (or the RA procedure initiated for BFR), the wireless device may transmit a third UL signal/message (e.g., PUCCH, PUSCH, SRS). The wireless device may transmit the third UL signal/message via the second spatial filter that is indicated by the DL message. The wireless device may transmit the third UL signal/message via the second spatial filter indicated by the DL message, for example, based on the DL message indicating the second spatial filter. The wireless device may transmit the third UL signal/message via the second spatial filter that is indicated by the DL message, for example, based on the transmitting the third UL signal/message after M symbols after the completion of the BFR (or the RA procedure initiated for BFR). The wireless device may transmit the third UL signal/message via/on/using the first UL resource(s). The wireless device may transmit the third UL signal/message via the second spatial filter that is indicated by the DL message, for example, based on the first UL resource(s) being (after) M symbols after the completion of the BFR (or the RA procedure initiated for BFR).

The wireless device may receive a second DL message. The wireless device may receive the second DL message, for example, after transmitting the second UL signal/message. The second DL message may be, for example, an activation command. The second DL message may be, for example, activation command for PUCCH-SpatialRelationInfo. The one or more configuration parameters may indicate the PUCCH-SpatialRelationInfo. The second message may be, for example, the PUCCH-SpatialRelationInfo. The second DL message may indicate a third spatial filter. In an example, the third spatial filter may be the same as the first spatial filter. In an example, the third spatial filter may be different from (e.g., may not be the same as) the first spatial filter. In an example, the third spatial filter may be the same as the second spatial filter (e.g., Spatial filter 1 in FIG. 17). In an example, the third spatial filter may be different from (e.g., may not be the same as) the second spatial filter. In an example, the plurality of spatial filters may comprise the third spatial filter. In an example, the plurality of spatial filters may not comprise the third spatial filter. In an example, the second DL message may activate the third spatial filter. In an example, the second DL message may indicate/activate the third spatial filter for the first UL resource(s). The one or more configuration parameters may indicate the third spatial filter. The one or more configuration parameters may, for example, indicate a second plurality of spatial filters. The second plurality of spatial filters may comprise the third spatial filter.

The wireless device may transmit a fourth UL signal/message (e.g., PUCCH, PUSCH, SRS). The wireless device may transmit the fourth UL signal/message, for example, after receiving the second DL message. The wireless device may transmit the fourth UL signal/message, for example, using/with/via the third spatial filter. The wireless device may transmit the fourth UL signal/message, for example, using/with/via the third spatial filter, for example, based on the second DL message indicating the third spatial filter.

In the example of FIG. 17, the wireless device may set (e.g., determine, assign, use, consider, assume, and the like) a counter (e.g., preamble transmission counter, PREAMBLE_TRANSMISSION_COUNTER, preamble transmission counter per coverage enhancement (CE) level, and the like) to a first value. The counter may track/count a number of transmissions of an RA preamble. The counter may track/count a number of (RACH/PRACH) attempts of transmitting RA preamble(s) within/in an RA procedure. For example, the wireless device may set the counter to the first value before/prior to transmitting/performing the plurality of PRACH transmissions, as shown in FIG. 17. The wireless device may not increment or decrement (e.g., may not change) a value (e.g., the first value) of the counter between/during each/any PRACH transmission of the plurality of PRACH transmissions. The plurality of PRACH transmissions may be considered to be part of a single RACH/PRACH attempt. The wireless device may maintain (e.g., keep the same, not change, sustain, retain, suspend, pause, and the like) the value (e.g., the first value) of the counter between/during each/any PRACH transmission of the plurality of PRACH transmissions. The wireless device may not start a time window (e.g., ra-ResponseWindow) prior to/before transmitting each/every/all PRACH transmissions of the plurality of PRACH transmissions. In an example, the wireless device may not receive the DL message (e.g., RAR, PDCCH, DCI, and the like) prior to/before transmitting each/every/all PRACH transmissions of the plurality of PRACH transmissions.

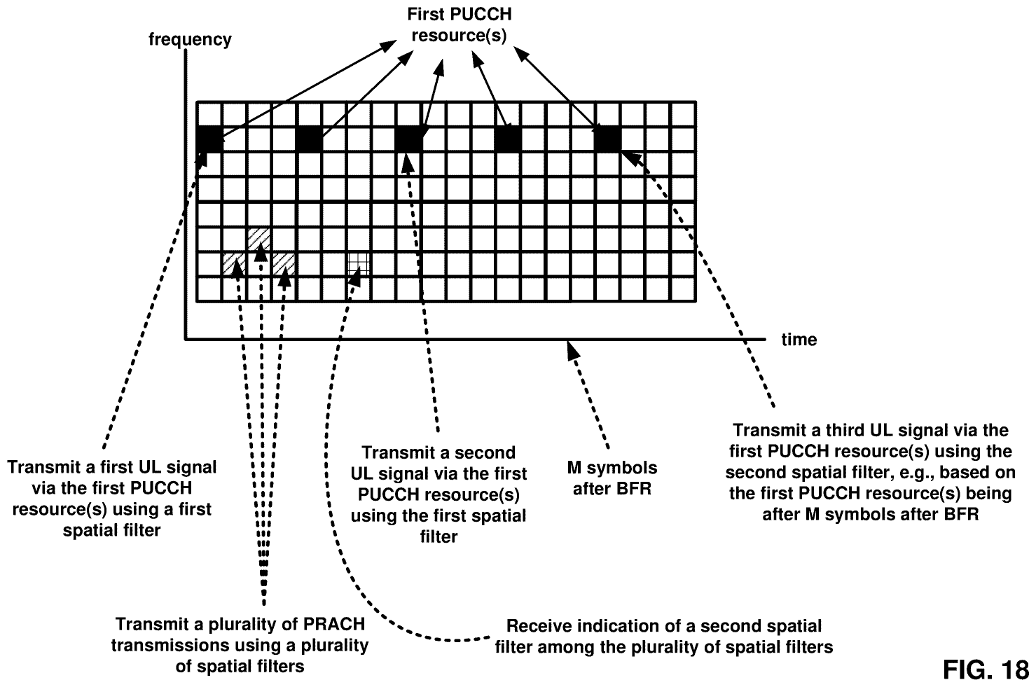

FIG. 18 shows an example resource grid diagram as per an aspect of an embodiment of the present disclosure. According to the example of FIG. 18, a wireless device may receive, from a base station, one or more configuration parameters of a cell. The one or more configuration parameters may indicate first UL resource(s) (e.g., PUCCH resource(s), PUSCH resource(s), SRS resource(s). The wireless device may transmit a first UL signal/message (e.g., PUCCH, PUSCH, SRS) via/over/using the first UL resource(s). The wireless device may transmit the first UL signal/message using/with/via a first spatial filter.

The wireless device may determine a beam failure (e.g., after transmitting the first UL signal/message). The wireless device may initiate/trigger a BFR, e.g., of/for the cell. The wireless device may perform/initiate an RA procedure (via/on/for/of/to the cell), for example, for the BFR (or based on initiating/triggering the BFR). The wireless device may transmit/perform a plurality of PRACH transmissions (e.g., one or more repetitions (each) of one or more RA preambles) for the RA procedure. The wireless device may transmit/perform the plurality of PRACH transmissions using/with/via a plurality of spatial filters.

In an example, the plurality of spatial filters may comprise the first spatial filter. In an example, the plurality of spatial filters may not comprise the first spatial filter (e.g., based on the beam failure corresponding to (or being associated with) the first spatial filter).

The wireless device may receive a DL message, for example, in response to transmitting/performing the plurality of PRACH transmissions. The DL message may indicate a second spatial filter from/among/of the plurality of spatial filters.

The wireless device may transmit a second UL signal/message, for example, after receiving the DL message. The wireless device may transmit the second UL signal/message on/via/using the first UL resource(s). The wireless device may transmit the second UL signal/message using/with/via the first spatial filter (e.g., and not the second spatial filter). The wireless device may transmit the second UL signal/message using/with/via the first spatial filter, for example, despite the DL message indicating the second spatial filter. The wireless device may transmit the second UL signal/message using/with/via the first spatial filter (e.g., and not the second spatial filter indicated by/in the DL message), for example, in response to not completing (or not being after M symbols after completing) the BFR (or the RA procedure initiated for the BFR) when transmitting the second UL signal/message. The wireless device may transmit the second UL signal/message using/with/via the first spatial filter (e.g., and not the second spatial filter indicated by/in the DL message), for example, based on (or in response to) the first UL resource(s) being before a completion (or before M symbols after the completion) of the BFR (or the RA procedure (initiated) for the BFR). The wireless device may transmit the second UL signal/message using/with/via the first spatial filter, for example, based on (or in response to) the first UL resource(s) being before M (M=14, 28, 42, etc.) symbols after the completion of the BFR (or the RA procedure (initiated) for the BFR).

The wireless device may transmit a third UL signal/message, for example, after M symbols after the completion of the BFR. The wireless device may transmit the third UL signal/message, for example, using/via/on the first UL resource(s). The wireless device may transmit the third UL signal/message, for example, via/with/using the second spatial filter. The wireless device may transmit the third UL signal/message via/with/using the second spatial filter, for example, based on the DL message indicating the second spatial filter. The wireless device may transmit the third UL signal/message via/with/using the second spatial filter, for example, based on transmitting the third UL signal/message after M symbols after the competition of the BFR. The wireless device may transmit the third UL signal/message via/with/using the second spatial filter, for example, based on the first UL resource(s) being after M (M=14, 28, 42, etc.) symbols after the completion of the BFR (or the RA procedure (initiated) for the BFR).

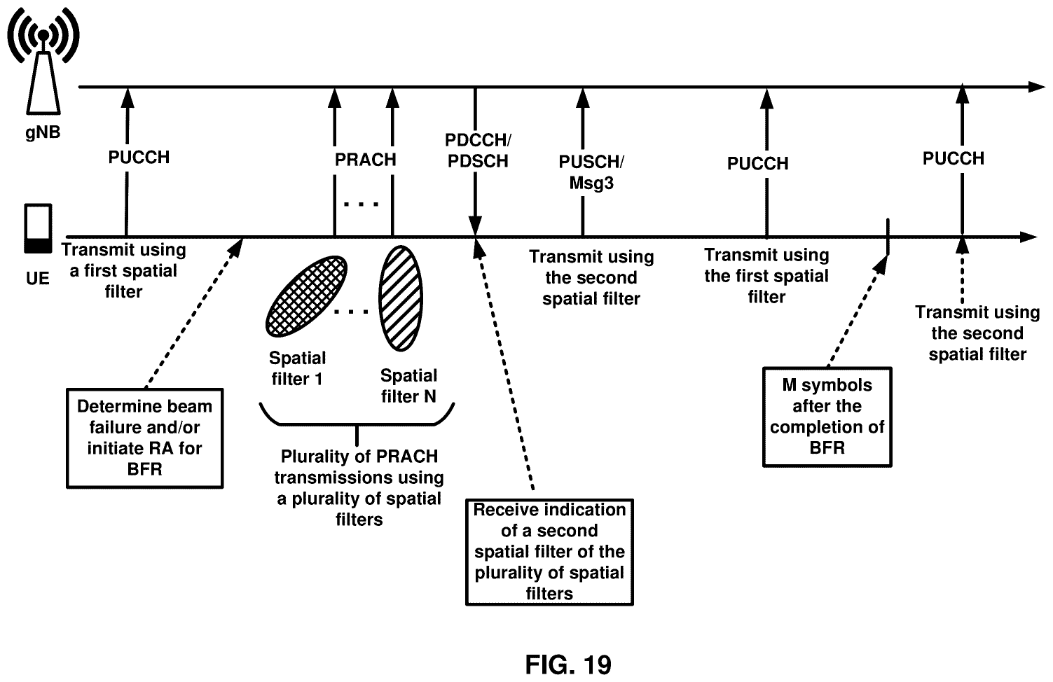

FIG. 19 shows an example timing diagram as per an aspect of an embodiment of the present disclosure. According to the example of FIG. 19, a wireless device may transmit a first UL signal/message (e.g., PUCCH, PUSCH, SRS) using/with/via a first spatial filter. The wireless device may transmit the first UL signal/message (e.g., PUCCH, PUSCH, SRS) using/on/via first UL resource(s) (e.g., PUCCH resource(s), PUSCH resource(s), SRS resource(s). The wireless device may receive one or more configuration parameters for/for a cell from a base station. The one or more configuration parameters may indicate the first UL resource(s). The wireless device may detect a beam failure (e.g., after transmitting the first UL signal/message). The wireless device may trigger/initiate a BFR (e.g., after transmitting the first UL signal/message). The wireless device may initiate/perform an RA procedure (in/via/for the cell), for example, for the BFR (e.g., based on triggering/initiating the BFR).

In the example of FIG. 19, the RA procedure may be a contention based RA (CBRA) procedure. The RA procedure may be, for example, a Type-1 (or 4-step) RA procedure. The wireless device may transmit/perform a plurality of PRACH transmissions (e.g., one or more repetitions (each) of one or more RA preambles) for the RA procedure. The wireless device may transmit/perform the plurality of PRACH transmissions using/with/via a plurality of spatial filters.

In an example, the plurality of spatial filters may comprise the first spatial filter. In an example, the plurality of spatial filters may not comprise the first spatial filter.

The wireless device may receive a DL message, for example, in response to transmitting/performing the plurality of PRACH transmissions. The DL message may be, for example, a PDCCH/DCI. The wireless device may receive the DL message on a search space indicated by recoverySearchSpaceId. The DL message may be, for example, Msg2. The DL message may be, for example, MsgB. The DL message may be, for example, a PDSCH/RAR.

The DL message may indicate, for example, a second spatial filter from/of/among the plurality of spatial filters.

In an example, the wireless device may transmit an RA message (e.g., Msg3, PUSCH, Msg5, PUCCH comprising HARQ-ACK for/of Msg4, and the like) using/with the second spatial filter. The wireless device may transmit the RA message, for example, after receiving the DL message. The wireless device may transmit the RA message using/with the second spatial filter, for example, based on (or in response to) the DL message/base station indicating the second spatial filter.

In another example embodiment, the wireless device may transmit the RA message using/with the first spatial filter (and not the second spatial filter, or any spatial filter that is not the second spatial filter), for example, despite the base station/DL message indicating the second spatial filter. The wireless device may not use the second spatial filter to transmit the RA message, for example, based on the RA procedure being a CBRA procedure. In a CBRA procedure, a contention (among one or more wireless devices) may be resolved after receiving a second DL message, e.g., Msg4. Until receiving the second DL message (e.g., Msg4) the wireless device may not know whether the DL message is intended for the wireless device or a second wireless device. For example, the wireless device and the second wireless device may transmit/perform one or more PRACH transmissions (e.g., using a same RA preamble and/or via/on/using a same RA resource, e.g., RACH occasion). The base station may transmit the DL message in response to (receiving) a PRACH transmission of the one or more PRACH transmissions. The PRACH transmission may be transmitted by the second wireless device. The base station may intend (to send/transmit) the DL message for the second wireless device. The second wireless device may receive the DL message. The wireless device may (also) receive the DL message. The second spatial filter indicated by/in the DL message may be (intended) for the second wireless device.

In an example, the DL message may indicate the second spatial filter. The DL message may indicate the second spatial filter, for example, based on the DL message scheduling a RA message retransmission (e.g., Msg3 transmission). The DL message may indicate the second spatial filter, for example, based on the DL message being/comprising a DCI with CRC scrambled by TC-RNTI. The DL message may indicate the second spatial filter, for example, based on the DL message being/comprising an RAR UL grant. In an example, the DL message may not indicate the second spatial filter based on the DL message scheduling an initial transmission of the RA message. For example, the DL message may not indicate the second spatial filter based on the DL message being/comprising an RAR UL grant (or being/comprising a DCI with CRC scrambled by TC-RNTI).

In an example, the DL message may indicate the second spatial filter. The DL message may indicate the second spatial filter, for example, based on the DL message scheduling an initial transmission of the RA message. The DL message may indicate the second spatial filter, for example, based on the DL message being/comprising a DCI with CRC scrambled by TC-RNTI. The DL message may indicate the second spatial filter, for example, based on the DL message being/comprising an RAR UL grant. In an example, the DL message may not indicate the second spatial filter based on the DL message scheduling a retransmission of the RA message. For example, the DL message may not indicate the second spatial filter based on the DL message being/comprising an RAR UL grant (or being/comprising a DCI with CRC scrambled by TC-RNTI).

The wireless device may transmit a second UL signal/message (e.g., PUCCH, PUSCH, SRS). The wireless device may transmit the second UL signal/message, for example, before M (M=7, 14, 28, etc.) symbols after a completion of the BFR (or the RA procedure initiated for the BFR). The wireless device may transmit the second UL signal/message, for example, before the completion of BFR (or the RA procedure initiated for the BFR). The wireless device may transmit the second UL signal/message, for example, after receiving the DL message. The wireless device may not use the second spatial filter (e.g., indicated by the DL message) to transmit the second UL signal/message, for example, based on transmitting the second UL signal/message before M symbols after the completion of the BFR. The wireless device may transmit the second UL signal/message using/with/via the first spatial filter, for example, based on transmitting the second UL signal/message before M symbols after the completion of the BFR. The wireless device may transmit the second UL signal/message, for example, via the first UL resource(s). The wireless device may not use the second spatial filter (e.g., indicated by the DL message) to transmit the second UL signal/message, for example, based on the first UL resource(s) being before M symbols after the completion of the BFR (or being before the completion of the BFR). The wireless device may transmit the second UL signal/message via/using/with the first spatial filter, for example, based on the first UL resource(s) being before M symbols after the completion of the BFR.

The wireless device may transmit a third UL signal/message (e.g., PUCCH, PUSCH, SRS). The wireless device may transmit the third UL signal/message, for example, using/via/on the first UL resource(s).

The wireless device may transmit the third UL signal/message, for example, using/with/via the second spatial filter indicated by/in the DL message. The wireless device may transmit the third UL signal/message using/with/via the second spatial filter indicated by/in the DL message, for example, based on transmitting the third UL signal/message after M symbols after the completion of the BFR (or the RA procedure, e.g., initiated for/triggered by the BFR). For example, after the completion of the BFR, the wireless device may know that the second spatial filter indicated by/in the DL message/base station may be (intended) for/to the wireless device (e.g., and not to/for a second wireless device).

The wireless device may transmit the third UL signal/message using/with/via the second spatial filter (e.g., indicated by/in the DL message), for example, based on using the second spatial filter to transmit the RA message (e.g., Msg3, PUSCH, and the like). The wireless device may transmit the third UL signal/message using/with/via the second spatial filter, for example, based on the first UL resource(s) (e.g., used for transmitting the third UL signal/message) being after M symbols after the competition of the BFR (or the RA procedure, e.g., initiated for/triggered by the BFR). The wireless device may transmit the third UL signal/message using/with/via the second spatial filter, for example, based on receiving a DCI (e.g., DCI format 1_0) with CRC scrambled by a corresponding TC-RNTI scheduling a PDSCH that includes a contention resolution identity of the wireless device (and/or the DCI (e.g., DCI format 1_0) with CRC scrambled by a corresponding TC-RNTI scheduling a PDSCH that includes a contention resolution identity of the wireless device indicating the second spatial filter).

The wireless device may transmit the third UL signal/message using/with/via the second spatial filter, for example, based on one or more of (or at least one of): transmitting the third UL signal/message after M symbols after the completion of the BFR (or the RA procedure, e.g., initiated for/triggered by the BFR); using the second spatial filter to transmit the RA message (e.g., Msg3, PUSCH, and the like); the first UL resource(s) (e.g., used for transmitting the third UL signal/message) being after M symbols after the competition of the BFR (or the RA procedure, e.g., initiated for/triggered by the BFR); receiving the DCI (e.g., DCI format 1_0) with CRC scrambled by the corresponding TC-RNTI scheduling the PDSCH that includes the contention resolution identity of the wireless device; receiving the PDSCH with the contention resolution identity of the wireless device (e.g., Msg4); receiving a medium access control (MAC) protocol data unit (PDU) comprising a Contention Resolution Identity MAC CE of the wireless device; and/or receiving the MAC PDU comprising the Contention Resolution Identity MAC CE of the wireless device that matches the Contention Resolution Identity of the wireless device (or the CCCH SDU) transmitted in the RA message (e.g., Msg3, PUSCH, and the like).

In some embodiments, a spatial filter may be, for example, same as (or may be referred to as, or may comprise) a spatial domain filter. In an example, a spatial filter may be same as (or may be referred to as, or may comprise) a spatial domain transmission/transmit filter. In an example, a spatial filter may be same as (or may be referred to as, or may comprise) a spatial domain reception/receive filter. In an example, a spatial filter may be same as (or may be referred to as, or may comprise) a (TX/transmit) beam. In an example, a spatial filter may be same as (or may be referred to as, or may comprise) a spatial relation (information/assumption). In an example, a spatial filter may be same as (or may be referred to as, or may comprise) a TCI state and/or quasi co location (QCL) relation/assumption.

In an example, a PRACH transmission may be the same as an RA preamble transmission. Performing a PRACH transmission may comprise (or be the same as) transmitting an RA preamble. A plurality of PRACH transmissions (or performing a plurality of PRACH transmissions) may, for example, comprise transmitting a plurality of RA preambles. A plurality of PRACH transmissions (or performing a plurality of PRACH transmissions) may comprise, for example, transmitting a plurality of RA preambles, wherein each RA preamble of the plurality of RA preambles is different from one another. A plurality of PRACH transmissions (or performing a plurality of PRACH transmissions) may comprise, for example, transmitting a plurality of RA preambles, wherein one or more RA preambles of the plurality of RA preambles may be the same as each other. A first RA preamble (e.g., of the plurality of RA preambles) may be the same as a second RA preamble (e.g., of the plurality of RA preambles), for example, based on a first preamble identity (e.g., PRAMBLE_INDEX, RA preamble identity/index/identifier (RAPID), and the like) of the first RA preamble being the same as a second RA preamble identity of the second RA preamble. In an example, a PRACH transmission may be the same as a random access channel (RACH) transmission. Performing a PRACH transmission may comprise (or be the same as) performing a RACH transmission.

In an example, performing/transmitting a plurality of PRACH transmissions may comprise transmitting one or more repetitions (each) of one or more RA preambles. For example, performing/transmitting a plurality of PRACH transmissions may comprise transmitting one/no repetitions each of a plurality of RA preambles (wherein each/one or more RA preambles of the plurality of RA preambles are different from each other). For example, performing/transmitting a plurality of PRACH transmissions may comprise transmitting a plurality of repetitions of a single/same RA preamble. For example, performing/transmitting a plurality of PRACH transmissions may comprise transmitting one or more repetitions of a first RA preamble and no repetitions of a second RA preamble.

The wireless device may determine (e.g., derive, compute, calculate, and the like) the plurality of spatial filters (in the example embodiments of FIGS. 17-19) for the plurality of PRACH transmissions, for example, based on a beam correspondence capability.

Example embodiments in the present disclosure (e.g., FIGS. 17-19), e.g., for determining a (e.g., default) spatial filter (e.g., to use for UL/DL communication) after BFR, may be different from (e.g., may not be same as) a beam refinement procedure (e.g., determining a spatial filter with the beam refinement procedure). With/in/during/at/after/under the beam refinement procedure, a wireless device may transmit/perform a plurality of PRACH transmissions (e.g., RA preambles), e.g., for an RA procedure, with/using a plurality of spatial filters. The wireless device may determine (e.g., derive, compute, calculate, and the like) the plurality of spatial filters, for example, based on a beam correspondence capability. For example, the wireless device may determine an RS (e.g., for the RA procedure). The wireless device may determine the plurality of spatial filters based on the RS. Any/each spatial filter of the plurality of spatial filters may be suitable for UL/DL communication. For example, a base station may receive any/each PRACH transmission of the plurality of PRACH transmissions transmitted with the plurality of spatial filters. The beam refinement procedure (e.g., under/with/using the beam refinement procedure, the base station) may determine/indicate a (e.g., most suitable) spatial filter among the plurality of spatial filters (e.g., a best spatial filter among the plurality of spatial filters, wherein the plurality of spatial filters are (all) suitable for UL/DL communication). Different from the beam refinement procedure, during BFR (e.g., during the RA procedure initiated for BFR), there may be no guarantee that each/any spatial filter of the plurality of spatial filters may be suitable for UL/DL communication. For example, a first PRACH transmission (e.g., a first RA preamble) of the plurality of PRACH transmissions (e.g., RA preambles) transmitted with/using a first spatial filter, of the plurality of spatial filters, may not reach (e.g., be decoded, be successfully decoded, be received by, and the like) the base station during/in BFR (e.g., RA initiated for BFR). The first PRACH transmission of the plurality of PRACH transmissions transmitted with/using the first spatial filter, of the plurality of spatial filters, may reach (e.g., be decoded, be successfully decoded, be received by, and the like) the base station during the beam refinement procedure. The wireless device may receive a DL message from the base station indicating a spatial filter of the plurality of spatial filters (e.g., based on/in response to receiving one or more PRACH transmissions of the plurality of PRACH transmissions). In the beam refinement procedure, the base station may receive each PRACH transmission (e.g., preamble) of the plurality of PRACH transmissions. The base station may indicate a spatial filter, of the plurality of spatial filters, based on a PRACH transmission, of the plurality of PRACH transmissions, associated with a highest radio link quality (e.g., highest power, highest signal strength, highest RSRP, lowest BLER, and the like). In an RA procedure initiated for BFR, the base station may indicate a spatial filter, of the plurality of spatial filters, based on a PRACH transmission, of the plurality of PRACH transmissions, that is/being received (e.g., reached, decoded, and the like) by the base station.

The beam refinement procedure may be performed by the wireless device, for example, at any time when the wireless device is in a radio resource control connected (RRC_CONNECTED) state/mode. The BFR procedure may be performed (e.g., only after) one or more failures of one or more beam (e.g., as determined by a beam failure instance (BFI) counter, when the BFI counter exceeds a predetermined value, BFI_COUNTER being greater than (or equal to) beamFailureInstanceMaxCount).

In an example, the wireless device may transmit/perform a plurality of PRACH transmissions (e.g., one or more repetitions (each) of one or more RA preambles), for an RA procedure, with/using a plurality of spatial filters. The RA procedure may be a CBRA procedure. After transmitting/performing the plurality of PRACH transmissions (e.g., one or more repetitions (each) of one or more RA preambles), the wireless device may receive a DL message indicating a second spatial filter of the plurality of spatial filters. The wireless device may use the second spatial filter to transmit a UL message (e.g., Msg3, PUSCH transmission, PUCCH transmission), for example, in response to the RA procedure being associated with (e.g., initiated for) a beam refinement procedure (or the RA procedure not being associated with BFR). The wireless device may not use the second spatial filter to transmit an UL message (e.g., PUCCH transmission), for example, in response to initiating the RA procedure for BFR. The wireless device may not use the second spatial filter until after a number of symbols after completing the BFR/RA procedure, for example, based on (or in response to) initiating the RA procedure for BFR (e.g., example embodiments in FIGS. 17-19). Using (e.g., transmitting with) the second spatial filter before the end (or completion) of the BFR (or RA procedure) may result in undesirable consequences. For example, prior to the completion of the BFR, there may be no guarantee/assurance/indication that the second spatial filter is suitable for UL communication (e.g., for PUCCH transmission).

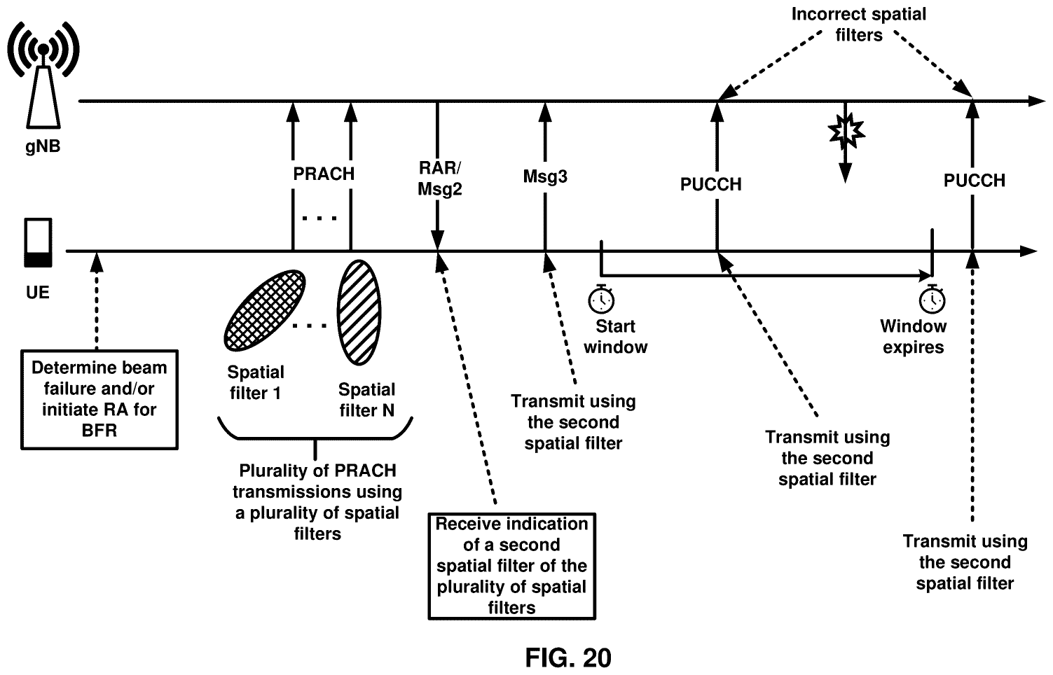

FIG. 20 shows an example timing diagram of an RA procedure. In the example of FIG. 20, a wireless device may detect a beam failure. The wireless device may transmit a first UL signal/message using a first spatial filter over/via/using first UL resource(s). The wireless device may trigger a BFR of/for/in the cell. The wireless device may initiate an RA procedure for the BFR. The wireless device may transmit/perform a plurality of PRACH transmissions using/with a plurality of spatial filter for the RA procedure. The wireless device may receive a DL message (e.g., RAR, Msg2) from the base station. The DL message may indicate a second spatial filter from/of/among the plurality of spatial filters. The wireless device may use the second spatial filter to transmit a Msg3 (e.g., an RA message). The wireless device may start a timer/time window (e.g., ra-ContentionResolutionTimer) in the first symbol after the end of all repetitions of the Msg3 transmission. The wireless device may (e.g., according to the implementation of the existing technologies) transmit a second UL signal/message (e.g., before expiry of the timer/time window) using the second spatial filter via/over/using the first UL resource(s), for example, based on the DL message indicating the second spatial filter. The wireless device may not receive a second DL message within/before an expiry of the timer/time window. For example, the wireless device may receive no PDCCH addressed to TC-RNTI indicating uplink grant for a Msg3 retransmission after start of the timer/time window (e.g., before the expiry of the timer/time window). The wireless device may determine/consider a Contention Resolution to be not successful (e.g., unsuccessful). The wireless device may determine/consider the BFR/RA procedure to be unsuccessful.

The wireless device may determine to retransmit one or more PRACH transmissions. The wireless device may transmit a third UL signal/message (e.g., after the expiry of the timer/time window) using/via/over the first UL resource(s). Based on the Contention Resolution being not successful, the second spatial filter indicated in/by the DL message may not be/have been (intended) for the wireless device. The second spatial filter indicated in/by the DL message may be/have been (intended) for a second wireless device. Based on using the second spatial filter for the second PUCCH signal/message and/or the third PUCCH signal/message (e.g., according to the implementation of the existing technologies), the wireless device may (have) use (d) an incorrect/wrong/inaccurate spatial filter for transmitting the second UL signal/message and/or the third UL signal/message. The wireless device may (e.g., in the implementation of the existing technologies) incorrectly reset (e.g., re-assign, use, apply, reuse, rewrite, and the like) a spatial relation (e.g., with the second spatial filter) of the first UL resources(s). The wireless device may incorrectly reset/change/modify/edit a (default) spatial filter for one or more transmissions associated with the first PUCCH resource(s) using the implementation of the existing technologies. Using an incorrect/wrong/inaccurate spatial filter for transmitting an UL signal/message may result in unnecessary retransmission(s) of the UL signal/message, additional signaling overhead, underutilization of network resources, reduction of throughput, increase in power consumption at the wireless device and/or a base station, and/or degraded battery life of the wireless device.

Using example embodiments according to the present disclosure, for example as described in FIG. 17-FIG. 19, the wireless device may not use the second spatial filter indicated in the DL message to transmit the second and/or third UL signal/message(s) (e.g., the wireless device may use the first spatial filter to transmit the second and/or third UL signal/message(s)). Using example embodiments according to the present disclosure, for example as described in FIG. 17-FIG. 19, the wireless device may not incorrectly reset/change/modify/edit a (default) spatial filter for one or more transmissions associated with the first PUCCH resource(s).

In the example embodiments of the present disclosure (e.g., FIG. 17-FIG. 19) triggering/initiating a BFR may comprise initiating the RA procedure for the BFR. Triggering/initiating a BFR may comprise transmitting a BFR MAC CE to/via a serving cell (e.g., SCell).

In an example, a wireless device transmitting/performing a (single) PRACH transmission may comprise transmitting a (single) RA preamble. In an example, the wireless device transmitting/performing a plurality of PRACH transmissions may comprise transmitting a single RA preamble for a plurality of times (e.g., a plurality of repetitions of the (single) RA preamble.) In an example, the wireless device transmitting/performing a plurality of PRACH transmissions may comprise transmitting one or more repetitions (each) of one or more RA preambles (e.g., a first number of repetitions (e.g., wherein the first number is greater than one) of a first RA preamble and a second number (e.g., wherein the second number is greater than one) of repetitions of a second RA preamble, a single repetition (or no repetition) of a first RA preamble and a single repetition (or no repetition) of a second RA preamble, a single repetition (or no repetition) of a first RA preamble and a number (e.g., wherein the number is greater than one) of repetitions of a second RA preamble, and/or combination(s) thereof).

A wireless device may initiate/perform an RA procedure. The wireless device may transmit/perform a PRACH transmission (e.g., an RA preamble) for the RA procedure. The RA procedure may be a CBRA procedure. The wireless device may transmit/perform the PRACH transmission via an RA resource. The RA resource may be part of a resource block (RB) set. For example, the RB set may comprise the RA resource. The wireless device may receive a DL message (e.g., PDCCH, DCI, RAR, RAR UL grant, DCI 0_0 with CRC scrambled by TC-RNTI, and the like) from a base station, for example, in response to transmitting/performing the PRACH transmission (e.g., the RA preamble). The DL message may schedule a UL transmission (e.g., Msg3 transmission, Msg3 retransmission, PUSCH transmission and the like). The wireless device may use the RB set to perform the UL transmission. For example, the wireless device may perform a listen-before-talk (LBT) procedure (e.g., channel access procedure) on the RB set prior to/for the UL transmission.

In an example, the wireless device may transmit/perform a plurality of PRACH transmissions (e.g., one or more repetitions (each) of one or more RA preambles), for the RA procedure (e.g., for coverage enhancement, to reduce latency, for beam refinement, and the like). For example, the plurality of PRACH transmissions may comprise a first PRACH transmission. The plurality of PRACH transmissions may comprise a second PRACH transmission. The wireless device may transmit/perform the first PRACH transmission via a first RA resource. The wireless device may transmit/perform the second PRACH transmission via a second RA resource. The first RA resource may be part of a first RB set. For example, the first RB set may comprise the first RA resource. The second RA resource may be part of a second RB set. For example, the second RB set may comprise the second RA resource. The wireless device may receive a DL message (e.g., PDCCH, DCI, RAR, RAR UL grant, DCI 0_0 with CRC scrambled by TC-RNTI, and the like) from the base station, for example, in response to transmitting/performing the plurality of PRACH transmissions. The DL message may schedule a UL transmission (e.g., Msg3 transmission, Msg3 retransmission, PUSCH transmission and the like). In the implementation of the existing technologies, the wireless device may not know whether to use the first RB set or the second RB set for the UL transmission. As a result, the wireless device may perform unnecessary LBT procedures, increase the power consumption of the wireless device, reduce the battery life of the wireless device, and/or increase interference.

In light of the existing technologies, there is a need to improve determining an RB set for a UL transmission (e.g., Msg3 transmission, Msg3 retransmission, PUSCH transmission, and the like) scheduled by a DL message (e.g., RAR UL grant, DCI 0_0 with CRC scrambled by TC-RNTI) when a plurality of PRACH transmissions (e.g., RA preamble(s) are transmitted/performed for an RA procedure using a plurality of RA resources that are part of a plurality of RB sets.

According to example embodiments of the present disclosure, a wireless device may transmit/perform a plurality of PRACH transmissions (e.g., RA preambles) via a plurality of RA resources belonging to (or that are a part of) a plurality of RB sets. For example, the plurality of RB sets may comprise the plurality of RA resources, wherein each RB set of the plurality of RB sets comprise a respective RA resource of the plurality of RA resources. The wireless device may receive a DL message from a base station in response to transmitting/performing the plurality of PRACH transmissions. The DL message may indicate an RB set of the plurality of RB sets. The DL message may schedule a UL transmission. The wireless device may use the RB set, of the plurality of RB sets, that is indicated by/in the DL message for the UL transmission.

Based on the wireless device using the RB set indicated by/in the DL message (or indicated by the base station), the wireless device may know which RB set, of the plurality of RB sets, to use for a UL transmission scheduled by the DL message. There may be a common understanding between the base station and the wireless device about the RB set to use for the UL transmission. Based on the common understanding the base station may suitably schedule resources for the UL transmission such that interference may be reduced. Based on using the RB set indicated by/in the DL message, the wireless device may not perform unnecessary LBT procedures. As a result, the power consumption in the wireless device may be reduced and/or the battery life of the wireless device may be improved.

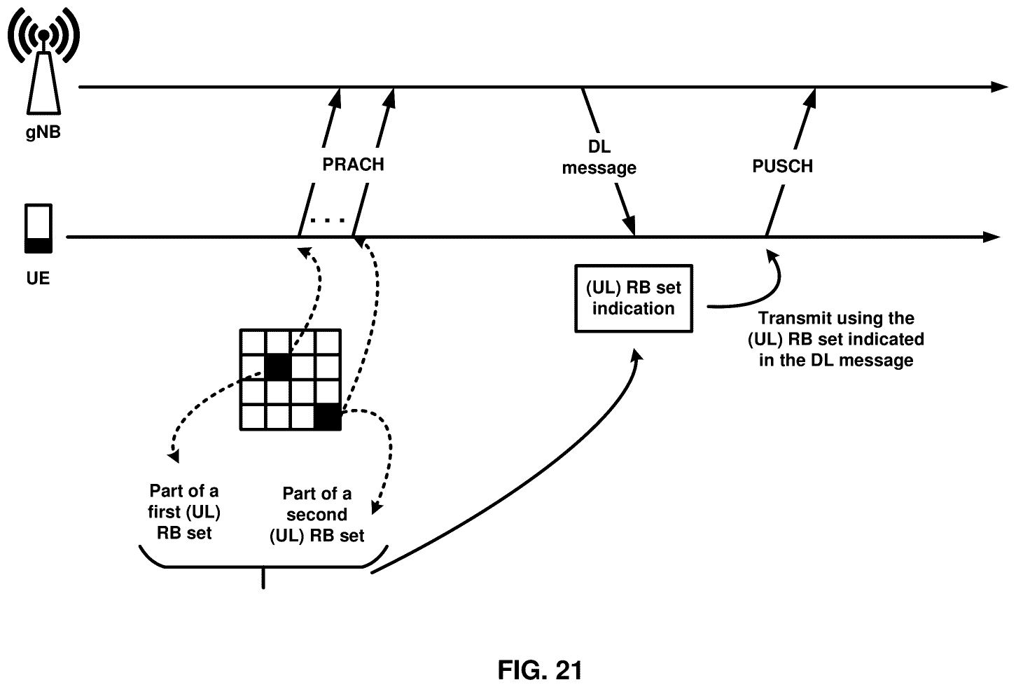

FIG. 21 shows an example timing diagram as per an aspect of an embodiment of the present disclosure. In the example embodiment of FIG. 21, a wireless device may transmit/perform a plurality of PRACH transmissions (e.g., plurality of repetitions of an RA preamble, one or more repetitions (each) of a plurality of RA preambles, and the like). The wireless device may transmit/perform the plurality of PRACH transmissions, for example, for an RA procedure. The RA procedure may be associated with a cell (e.g., the RA procedure may be of/for/on/via the cell). The wireless device may transmit/perform the plurality of PRACH transmissions, for example, to a base station.

In an example, the wireless device may use a same spatial filter for each PRACH transmission of the plurality of PRACH transmissions. In an example, the wireless device may use a plurality of spatial filters for the plurality of PRACH transmissions. For example, for each PRACH transmission of the plurality of PRACH transmissions, the wireless device may use a respective spatial filter of the plurality of spatial filters.

The plurality of PRACH transmissions may comprise, for example, a first PRACH transmission (e.g., a first RA preamble). The plurality of PRACH transmissions may comprise, for example, a second PRACH transmission (e.g., a second RA preamble). In an example, the first RA preamble may be the same as the second RA preamble. In another example, the first RA preamble may be different from (e.g., not the same as) the second RA preamble.

The wireless device may transmit/perform the first PRACH transmission (e.g., the first RA preamble) via/using/over/on a first RA resource. The wireless device may transmit/perform the second PRACH transmission (e.g., the second RA preamble) via/using/over/on a second RA resource.

A first (UL) RB set may, for example, comprise the first RA resource (e.g., as shown in FIG. 21). A second (UL) RB set may, for example, comprise the second RA resource (e.g., as shown in FIG. 21). The first RA resource may be part of the first (UL) RB set. The second RA resource may be part of the second (UL) RB set. The first (UL) RB set may not comprise the second RA resource. The second (UL) RB set may not comprise the first RA resource. A plurality of (UL) RB sets may comprise the first (UL) RB set and the second (UL) RB set.

The wireless device may receive a DL message. The wireless device may receive the DL message from a base station. The wireless device may receive the DL message, for example, in response to (transmitting/performing) the plurality of PRACH transmissions. The wireless device may receive the DL message from the base station. The base station/DL message may indicate a (UL) RB set from/among/out of/of the plurality of (UL) RB sets (e.g., first (UL) RB set and the second (UL) RB set).

In an example, the DL message may indicate the (UL) RB set implicitly.

In an example, the plurality of PRACH transmissions may comprise a plurality of RA preambles (e.g., the first RA preamble and the second RA preamble). The first RA preamble may be associated with a first preamble index (e.g., PREAMBLE_INDEX, RA preamble identity (RAPID), and the like). The second RA preamble may be associated with a second preamble index. The first preamble index and the second preamble index may be different (e.g., not the same, may not match, and the like). In an example, the first preamble index and the second preamble index may be the same. The wireless device may transmit the first RA preamble using/with/over/via, for example, the first RA resource that is part of (or comprised in) the first (UL) RB set. The wireless device may transmit the second RA preamble using/with/via/over/on, for example, the second RA resource that is part of (or comprised in) the second (UL) RB set.

In an example embodiment, the DL message may indicate (e.g., comprise, parsed, be associated with) the first preamble index. The DL message may, for example, comprise a MAC subPDU with a preamble index corresponding to the first preamble index. The DL message may indicate the first (UL) RB set, for example, based on the DL message indicating the first preamble index (and/or the DL message comprising a MAC subPDU with a preamble index corresponding to the first preamble index). The DL message may indicate the first (UL) RB set, for example, based on the DL message indicating the first preamble index (and/or the DL message comprising a MAC subPDU with a preamble index corresponding to the first preamble index) and/or the wireless device transmitting the first RA preamble (that is associated with the first preamble index) using/with/via/on/over the first RA resource that is part of/associated with (or comprised in) the first (UL) RB set.

In an example, the DL message may indicate (e.g., comprise, parsed, be associated with) the second preamble index. The DL message may, for example, comprise a MAC subPDU with a preamble index corresponding to the second preamble index. The DL message may indicate the second (UL) RB set, for example, based on the DL message indicating the second preamble index (and/or the DL message comprising a MAC subPDU with a preamble index corresponding to the second preamble index). The DL message may indicate the second (UL) RB set, for example, based on the DL message indicating the second preamble index (and/or the DL message comprising a MAC subPDU with a preamble index corresponding to the second preamble index) and/or the wireless device transmitting the second RA preamble (that is associated with the second preamble index) using/with/over/on/via the second RA resource that is part of/associated with (or comprised in) the second (UL) RB set.

In an example embodiment, the plurality of PRACH transmissions may comprise a first PRACH transmission (e.g., a first RA preamble). The plurality of PRACH transmissions may comprise a second PRACH transmission (e.g., the second RA preamble). The wireless device may transmit/perform the first PRACH transmission with/using/comprising/indicating/associated with a first RA-RNTI. The wireless device may transmit/perform the second PRACH transmission with/using/comprising/indicating/associated with a second RA-RNTI.

In an example, the DL message may indicate the first RA-RNTI. For example, the DL message may comprise a valid DL assignment on a PDCCH for the first RA-RNTI. The DL message may be, for example, an RAR identified by the first RA-RNTI. The DL message may indicate the first (UL) RB set, for example, based on the DL message indicating the first RA-RNTI (e.g., based on the DL message comprising the valid DL assignment on the PDCCH for the first RA-RNTI, the DL message comprising the RAR identified by the first RA-RNTI). The DL message may indicate the first (UL) RB set, for example, based on the DL message indicating the first RA-RNTI (e.g., based on the DL message comprising the valid DL assignment on the PDCCH for the first RA-RNTI, the DL message comprising the RAR identified by the first RA-RNTI) and/or the wireless device transmitting the first PRACH transmission (that is associated with the first RA-RNTI) using/with/over/via/on the first RA resource that is part of/associated with (or comprised in) the first (UL) RB set.

In an example, the DL message may indicate the second RA-RNTI. For example, the DL message may comprise a valid DL assignment on a PDCCH for the second RA-RNTI. The DL message may be, for example, an RAR identified by the second RA-RNTI. The DL message may indicate the second (UL) RB set, for example, based on the DL message indicating the second RA-RNTI (e.g., based on the DL message comprising the valid DL assignment on the PDCCH for the second RA-RNTI, the DL message comprising the RAR identified by the second RA-RNTI). The DL message may indicate the second (UL) RB set, for example, based on the DL message indicating the second RA-RNTI (e.g., based on the DL message comprising the valid DL assignment on the PDCCH for the second RA-RNTI, the DL message comprising the RAR identified by the second RA-RNTI) and/or the wireless device transmitting the second PRACH transmission (that is associated with the second RA-RNTI) using/with/via/on/over the second RA resource that is part of/associated with (or comprised in) the second (UL) RB set.

In an example embodiment, the plurality of PRACH transmissions may comprise a first PRACH transmission (e.g., a first RA preamble). The plurality of PRACH transmissions may comprise a second PRACH transmission (e.g., the first RA preamble, a second RA preamble, and the like). The wireless device may transmit/perform the first PRACH transmission on/via/using the first RA resource (e.g., first RACH/RA occasion). The wireless device may transmit/perform the second PRACH transmission on/via/using the second RA resource (e.g., second RACH/RA occasion).

In an example, the DL message may indicate the first RA resource (e.g., the first RACH occasion). For example, the DL message may comprise a field indicating an index/identity/identifier that identifies the first RA resource. For example, the field may indicate a first RACH occasion (RO) index. The first RO index may indicate/identify the first RA resource (e.g., the first RACH occasion). The DL message may indicate the first (UL) RB set, for example, based on the DL message indicating the first RA resource (e.g., based on the DL message comprising the field indicating the index/identity/identifier that identifies the first RA resource). The DL message may indicate the first (UL) RB set, for example, based on the DL message indicating the first RA resource (e.g., based on the DL message comprising the field indicating the index/identity/identifier that identifies the first RA resource) and/or the wireless device transmitting the first PRACH transmission on/via/using the first RA resource that is part of/associated with (or comprised in) the first (UL) RB set.

In an example, the DL message may indicate the second RA resource (e.g., the second RACH occasion). For example, the DL message may comprise a field indicating an index/identity/identifier that identifies the second RA resource. For example, the field may indicate a second RACH occasion (RO) index. The second RO index may indicate/identify the second RA resource (e.g., the second RACH occasion). The DL message may indicate the second (UL) RB set, for example, based on the DL message indicating the second RA resource (e.g., based on the DL message comprising the field indicating the index/identity/identifier that identifies the second RA resource). The DL message may indicate the second (UL) RB set, for example, based on the DL message indicating the second RA resource (e.g., based on the DL message comprising the field indicating the index/identity/identifier that identifies the second RA resource) and/or the wireless device transmitting the second PRACH transmission on/via/using the first RA resource that is part of/associated with (or comprised in) the second (UL) RB set.

In an example, the DL message may comprise a plurality of commands (e.g., a plurality of MAC CEs, plurality of RARs, a plurality of PDSCH signals, a plurality of DCIs, and the like). Each command of the plurality of commands may indicate a respective (UL) RB set of/from/among the first (UL) RB set and the second (UL) RB set. For example, the plurality of commands may comprise a first command and a second command. The wireless device may receive the second command after (e.g., later in time) the first command. The first command may indicate the first (UL) RB set. The second command may indicate the second (UL) RB set. The DL message may indicate the second (UL) RB set, for example, based on the second (or last) command indicating the second (UL) RB set.

The DL message may, for example, comprise an RAR UL grant. For example, the DL message may schedule a UL transmission (e.g., a PUSCH transmission, a Msg3 transmission, Msg3 retransmission, and the like), e.g., using/via the RAR UL grant. The DL message may, for example, comprise a downlink control information (DCI). The DCI may be, for example, DCI format 0_0. The DCI format 0_0 may be with CRC scrambled by TC-RNTI. The DL message may schedule the UL transmission, for example, via/using the DCI format 0_0 with CRC scrambled by TC-RNTI.

The wireless device may transmit/perform the UL transmission (e.g., PUSCH, Msg3 transmission, UL signal/message, Msg3 retransmission, and the like), for example, using the (UL) RB set (e.g., one of the first (UL) RB set and/or the second (UL) RB set) indicated by/in the DL message (e.g., as shown in FIG. 21). For example, the wireless device may perform listen-before-talk (LBT) and/or channel sensing procedure(s) on/over the (UL) RB set indicated in/by the DL message, e.g., prior to/before the UL transmission.

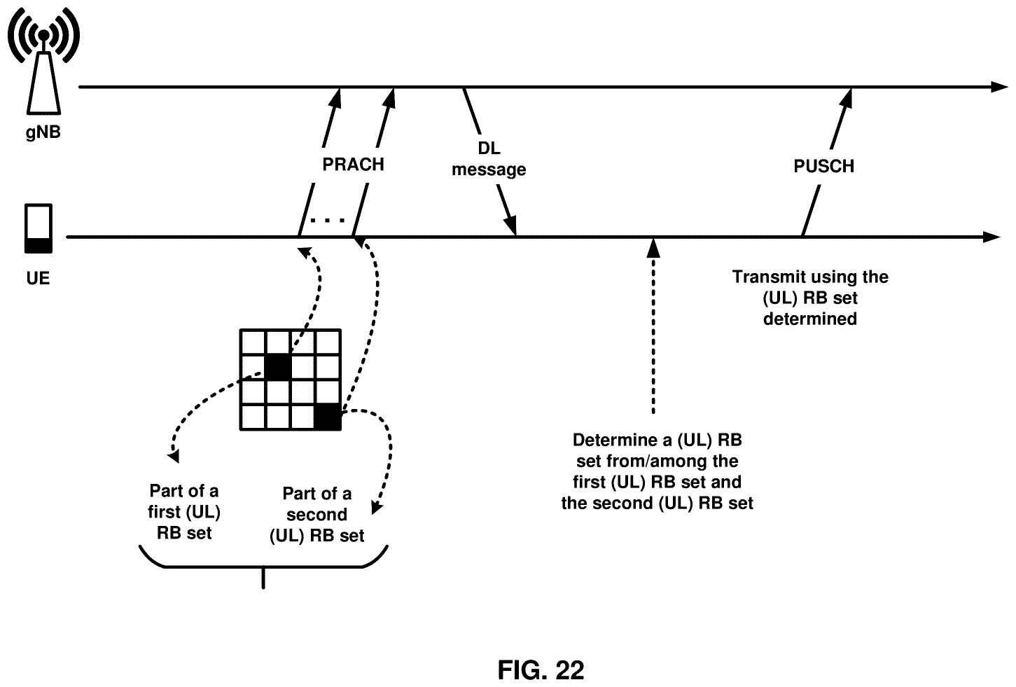

FIG. 22 shows an example timing diagram as per an aspect of an embodiment of the present disclosure. In the example embodiment of FIG. 22, the DL message may not indicate a (UL) RB set. The DL message may, for example, comprise an RAR UL grant. For example, the DL message may schedule a UL transmission (e.g., a PUSCH transmission, a Msg3 transmission, Msg3 retransmission, and the like), e.g., using/via the RAR UL grant. The DL message may, for example, comprise a downlink control information (DCI). The DCI may be, for example, DCI format 0_0. The DCI format 0_0 may be with CRC scrambled by TC-RNTI. The DL message may schedule the UL transmission, for example, via/using the DCI format 0_0 with CRC scrambled by TC-RNTI.

The wireless device may determine (e.g., select) a (UL) RB set (e.g., either the first (UL) RB set or the second (UL) RB set) from/among/amongst/of/out of the plurality of (UL) RB sets (e.g., the first (UL) RB set and the second (UL) RB set).

In an example, the wireless device may determine (e.g., select) a (UL) RB set (e.g., either the first (UL) RB set or the second (UL) RB set) from/among/amongst/of/out of the plurality of (UL) RB sets (e.g., the first (UL) RB set and the second (UL) RB set) based on the (UL) RB set being used for a first (e.g., first in time) PRACH transmission, of/among/from the plurality of PRACH transmissions.

In an example, the wireless device may determine (e.g., select) a (UL) RB set (e.g., either the first (UL) RB set or the second (UL) RB set) from/among/amongst/of/out of the plurality of (UL) RB sets (e.g., the first (UL) RB set and the second (UL) RB set) based on the (UL) RB set being used for a last (e.g., last in time) PRACH transmission, of/from/among the plurality of PRACH transmissions.

In an example, the wireless device may determine (e.g., select) a (UL) RB set (e.g., either the first (UL) RB set or the second (UL) RB set) from/among/amongst/of/out of the plurality of (UL) RB sets (e.g., the first (UL) RB set and the second (UL) RB set) based on not receiving an LBT failure indication during LBT procedure(s) for the plurality of PRACH transmissions. For example, the wireless device may perform LBT procedure(s) (e.g., channel access/sensing procedure) on/over/via one or more channels for the first PRACH transmission (e.g., transmitted over/via the first RA resources that are associated with the first (UL) RB set). The wireless device may not receive an LBT failure indication (e.g., may determine a channel to be free for PRACH transmission, may not sense the channel to be busy for PRACH transmission and the like) associated with the first (UL) RB set. For example, the wireless device may perform LBT procedure(s) (e.g., channel access/sensing procedure) on/over/via one or more channels for the second PRACH transmission (e.g., transmitted over/via the second RA resources that are associated with the second (UL) RB set). The wireless device may receive an LBT failure indication (e.g., may determine a channel to be busy for PRACH transmission, may sense the channel to be busy for PRACH transmission and the like) associated with the second (UL) RB set. The wireless device may determine the (UL) RB set to be the first (UL) RB set, for example, based on not receiving an LBT failure indication associated with the first (UL) RB set.

In an example, the wireless device may determine (e.g., select) a (UL) RB set (e.g., either the first (UL) RB set or the second (UL) RB set) from/among/amongst/of/out of the plurality of (UL) RB sets (e.g., the first (UL) RB set and the second (UL) RB set) based on the (UL) RB set being associated with a lowest (or highest) index (e.g., RB set index). In an example, the first (UL) RB set may be associated with a first RB set index. The second (UL) RB set may be associated with a second RB set index. The first RB set index may be higher (e.g., greater, larger, more, above, and the like) than the second RB set index. The second RB set index may be lower (e.g., smaller, less, below, and the like) than the first RB set index. The wireless device may determine the (UL) RB set to be the first (UL) RB set, for example, based on the first RB set index being higher than the second RB set index (or the first RB set index being highest among a plurality of RB set indexes, wherein each RB set index of the plurality of RB set indexes is associated with a respective (UL) RB set of the plurality of (UL) RB sets). In an example, the wireless device may determine the (UL) RB set to be the second (UL) RB set, for example, based on the second RB set index being lower (e.g., less, smaller, below, and the like) than the second RB set index (or the second RB set index being least among a plurality of RB set indexes, wherein each RB set index of the plurality of RB set indexes is associated with a respective (UL) RB set of the plurality of (UL) RB sets).

In an example, the wireless device may determine (e.g., select) a (UL) RB set (e.g., either the first (UL) RB set or the second (UL) RB set) from/among/amongst/of/out of the plurality of (UL) RB sets (e.g., the first (UL) RB set and the second (UL) RB set) based on the (UL) RB set being associated with a lowest (or highest) frequency (e.g., starting frequency of the (UL) RB set, ending frequency of the (UL) RB set, carrier frequency of the (UL) RB set, and the like). In an example, the first (UL) RB set may be associated with a first frequency. The second (UL) RB set may be associated with a second frequency. The first frequency may be higher (e.g., greater, larger, more, above, and the like) than the second frequency. The second frequency may be lower (e.g., less, smaller, weaker, below, and the like) than the first frequency. The wireless device may determine the (UL) RB set to be the first (UL) RB set, for example, based on the first frequency being higher than the second frequency (or the first frequency being highest among a plurality of frequencies, wherein each frequency of the plurality of frequencies is associated with a respective (UL) RB set of the plurality of (UL) RB sets). In an example, the wireless device may determine the (UL) RB set to be the second (UL) RB set, for example, based on the second frequency being lower (e.g., less, smaller, below, and the like) than the second frequency (or the second frequency being least among a plurality of frequencies, wherein each frequency of the plurality of frequencies is associated with a respective (UL) RB set of the plurality of (UL) RB sets).

The wireless device may use the (UL) RB set, of the plurality of (UL) RB sets, for the UL transmission (e.g., scheduled by the DL message). For example, the wireless device may perform listen-before-talk (LBT) and/or channel sensing procedure(s) on/over the (UL) RB set, e.g., prior to/before the UL transmission.

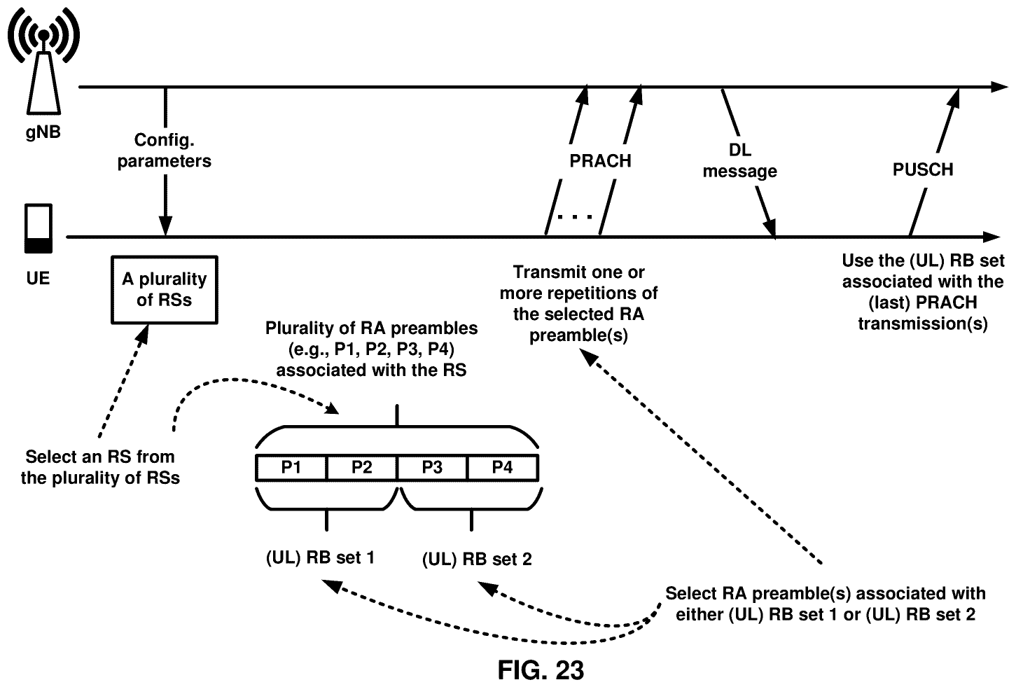

FIG. 23 shows an example embodiment as per an aspect of an embodiment of the present disclosure. According to the embodiment of FIG. 23, a wireless device may receive one or more configuration parameters of a cell from a base station. The one or more configuration parameters may indicate a plurality of reference signals (RSs). Each RS of the plurality of RSs may be a synchronization signal block (SSB), synchronization signal (SS)/physical broadcast channel (PBCH) block, channel state information-RS (CSI-RS), cell-specific RS (CRS), sounding RS (SRS), positioning RS (PRS), and the like.

The wireless device may determine an RS, of the plurality of RSs, for an RA procedure (of/for the cell). The wireless device may determine the RS, for example, based on a radio link quality of one or more RSs of the plurality of RSs. The radio link quality may be one or more of: RS received power (RSRP), RS received quality (RSRQ), received signal strength indicator (RSSI), signal to noise ratio (SNR), signal to interference plus noise ratio (SINR), block error rate (BLER), bit error rate (BER), signal power, received power, signal strength, pathloss, channel quality, and/or the like.

In an example, the wireless device may determine one or more radio link qualities associated with one or more RSs of the plurality of RSs. Each radio link quality of the one or more radio link qualities may be associated with a respective RS of the one or more RSs. The wireless device may determine (e.g., select, choose, pick, and the like) the RS, for example, based on a radio link quality of the RS being highest (e.g., greater, largest, most, tallest, above, and the like) among/from/out of/amongst the one or more radio link qualities.

The RS may be, for example, associated with a plurality of RA preambles (e.g., as shown in FIG. 23). In the example of FIG. 23, the plurality of RA preambles may comprise at least a first RA preamble (e.g., P1 in FIG. 23), a second RA preamble (e.g., P2 in FIG. 23), a third RA preamble (e.g., P3 in FIG. 23), and a fourth RA preamble (e.g., P4 in FIG. 23). Each RA preamble of the plurality of RA preamble may be associated with a respective (UL) RB set of a plurality of (UL) RB sets. The plurality of (UL) RB sets may comprise a first (UL) RB set (e.g., (UL) RB set 1 in FIG. 23) and a second (UL) RB set (e.g., (UL) RB set 2 in FIG. 23). In the example of FIG. 23, the first RA preamble (e.g., P1) may be associated with the first (UL) RB set (e.g., (UL) RB set 1). The second RA preamble (e.g., P2) may be associated with the first (UL) RB set (e.g., (UL) RB set 1). The third RA preamble (e.g., P3) may be associated with the second (UL) RB set (e.g., (UL) RB set 2). The fourth RA preamble (e.g., P4) may be associated with the second (UL) RB set (e.g., (UL) RB set 2).

An RA preamble may be associated with a (UL) RB set, for example, based on one or more RA resources (e.g., RACH occasions, starting RB, and the like) associated with (or mapped to) the RA preamble being a part of (or comprised in) the (UL) RB set. For example, P1 in FIG. 23 may be associated with (UL) RB set 1 in FIG. 23 based on one or more RA resources associated with P1 being a part of (or comprised in) (UL) RB set 1. An RA preamble may be associated with an (UL) RB set, for example, based on a mapping indicated/comprised/provided by the one or more configuration parameters. An RA preamble may be associated with an (UL) RB set, for example, based on the RA preamble being confined withing the (UL) RB set as indicated/comprised/provided by the one or more configuration parameters (e.g., via msg1-FrequencyStart, msgA-RO-FrequencyStart, msg1-FDM, and/or msgA-RO-FDM).

In the example of FIG. 23, the wireless device may determine (e.g., select, choose, pick, and the like) one or more RA preambles for the RA procedure.

In an example, the wireless device may determine (e.g., select) a single RA preamble for the RA procedure. The wireless device may determine (e.g., select) any one of P1, P2, P3, or P4, for example, randomly with equal probability.

In an example, the wireless device may determine (e.g., select) a second plurality of RA preambles for the RA procedure. The wireless device may determine (e.g., select) the second plurality of RA preambles, e.g., randomly with equal probability, from the RA preambles associated with an (e.g., only one) (UL) RB set (e.g., either (UL) RB set 1 or (UL) RB set 2 in FIG. 23). For example, the wireless device may determine (e.g., select) (the second plurality of RA preambles to comprise) the first RA preamble and the second RA preamble, for example, based on the first RA preamble and the second RA preamble being associated with a same (UL) RB set (e.g., (UL) RB set 1 in FIG. 23). In another example, the wireless device may determine (e.g., select) (the second plurality of RA preambles to comprise) the third RA preamble and the fourth RA preamble, for example, based on the third RA preamble and the fourth RA preamble being associated with a same (UL) RB set (e.g., (UL) RB set 2 in FIG. 23). The wireless device may not determine (e.g., select) (the second plurality of RA preambles to comprise) the first RA preamble and the third RA preamble, for example, based on the first/second RA preamble and the third/fourth RA preamble being associated with different (UL) RB sets.

The wireless device may transmit/perform a plurality PRACH transmissions (e.g., one or more repetitions of the second plurality of RA preambles) for the RA procedure. The wireless device may use the (UL) RB set (e.g., either (UL) RB set 1 or (UL) RB set 2 in FIG. 23) for the plurality of PRACH transmissions. The wireless device may use the (e.g., same) (UL) RB set (e.g., either (UL) RB set 1 or (UL) RB set 2 in FIG. 23) for each PRACH transmission of the plurality of PRACH transmission. The wireless device may perform/transmit the plurality of PRACH transmissions using/over/via/on a plurality of RA resources. For example, the wireless device may determine the plurality of RA resources. For example, the base station may indicate (e.g., the one or more configuration parameters may indicate) the plurality of RA resources. The plurality of RA resources may belong to (e.g., be a part of, be comprised in, and the like) the (UL) RB set (e.g., either (UL) RB set 1 or (UL) RB set 2 in FIG. 23). The plurality of RA resources may belong to (e.g., be a part of, be comprised in, and the like) the (UL) RB set (e.g., either (UL) RB set 1 or (UL) RB set 2 in FIG. 23), for example, based on the wireless device determining the second plurality of RA preambles to be associated with the (UL) RB set (e.g., either (UL) RB set 1 or (UL) RB set 2 in FIG. 23). The plurality of RA resources may belong to (e.g., be a part of, be comprised in, and the like) the (UL) RB set (e.g., either (UL) RB set 1 or (UL) RB set 2 in FIG. 23), for example, based on the one or more configuration parameters indicating the second plurality of RA preambles to be associated with the (UL) RB set (e.g., either (UL) RB set 1 or (UL) RB set 2 in FIG. 23).

The wireless device may receive a DL message, for example, in response to (or based on) (transmitting/performing) the plurality of PRACH transmissions. The DL message may, for example, comprise an RAR UL grant. For example, the DL message may schedule a UL transmission (e.g., a PUSCH transmission, a Msg3 transmission, Msg3 retransmission, and the like), e.g., using/via the RAR UL grant. The DL message may, for example, comprise a downlink control information (DCI). The DCI may be, for example, DCI format 0_0. The DCI format 0_0 may be with CRC scrambled by TC-RNTI. The DL message may schedule the UL transmission, for example, via/using the DCI format 0_0 with CRC scrambled by TC-RNTI. The DL message may not indicate an (UL) RB set.

The wireless device may transmit/perform the UL transmission (e.g., UL message/signal, PUSCH, Msg3 transmission, Msg3 retransmission, and the like). The wireless device may transmit/perform the UL transmission, for example, based on (or in response) to the DL message (scheduling the UL transmission). The wireless device may use, for example, a (UL) RB set of a last PRACH transmission (e.g., a last, in time, PRACH transmission of the plurality of PRACH transmissions) for the UL transmission (e.g., as the (UL) RB set of the active UL bandwidth part (BWP). The wireless device may assume (e.g., consider, determine, set and the like) that the (UL) RB set is defined as when the wireless device is not configured with intraCellGuardBandsUL-List (e.g., the one or more configuration parameters does not comprise intraCellGuardBandsUL-List).

The wireless device may use, for example, a (UL) RB set (e.g., either (UL) RB set 1 or (UL) RB set 2 in FIG. 23) of a first PRACH transmission (e.g., a first, in time, PRACH transmission of the plurality of PRACH transmissions) for the UL transmission (e.g., as the (UL) RB set of the active UL BWP).

The wireless device may use, for example, a (UL) RB set (e.g., either (UL) RB set 1 or (UL) RB set 2 in FIG. 23) of any (e.g., at random) PRACH transmission, of the plurality of PRACH transmissions, for the UL transmission (e.g., as the (UL) RB set of the active UL BWP).

The wireless device may use, for example, a (UL) RB set (e.g., either (UL) RB set 1 or (UL) RB set 2 in FIG. 23) of the plurality of PRACH transmissions for the UL transmission (e.g., as the (UL) RB set of the active UL BWP).

Using a (UL) RB set for a UL transmission may comprise, for example, performing LBT procedure(s) on/in/via the (UL) RB set for/prior to the UL transmission. Using a (UL) RB set for a UL transmission may comprise, for example, performing channel access/sensing procedure(s) on/in/via the (UL) RB set for/prior to the UL transmission.

A wireless device may, for example, perform a 2-step/Type-2 RA procedure. In an example, the wireless device may transmit/perform a PRACH transmission (e.g., RA preamble), for example, for the 2-step/Type-2 RA procedure. The wireless device may transmit/perform the PRACH transmission (e.g., RA preamble) using/with a first spatial filter. The wireless device may transmit/perform a PUSCH transmission, for example, for the 2-step/Type-2 RA procedure. A MsgA transmission may comprise the PRACH transmission and the PUSCH transmission. In the implementation of existing technologies, the wireless device may use the first spatial filter to transmit/perform the PUSCH transmission. The PRACH transmission and the PUSCH transmission may together be referred to as a MsgA transmission.

In an example, the wireless device may transmit/perform a plurality of PRACH transmissions (e.g., one or more repetitions of one or more RA preambles), for example, to enhance coverage, reduce latency, and/or for beam refinement. The wireless device may transmit/perform the plurality of PRACH transmissions using/with a plurality of spatial filters. The plurality of spatial filters may comprise a first spatial filter and a second spatial filter. In the implementation of the existing technologies, the wireless device may not know which spatial filter, of the plurality of spatial filters, to use (e.g., whether to use the first spatial filter or the second spatial filter) to transmit/perform PUSCH transmission(s) after the plurality of PRACH transmissions. The PUSCH transmission(s) may be part of a MsgA transmission. The MsgA transmission may comprise the plurality of PRACH transmission and the PUSCH transmission(s). Using a wrong spatial filter may lead to the base station not receiving/decoding one or more PRACH transmissions of the plurality of PRACH transmissions, the wireless device not being able to determine which spatial filter of the plurality of spatial filters is suitable for DL/UL communication, increase in base station complexity for monitoring a plurality of spatial filters for PUSCH transmission(s), reduction in battery life of the wireless device, increase in power consumption and the base station, increase in signaling overhead, and/or underutilization of network resources.

In light of the existing technologies, there is a need to improve determining spatial filter(s) for PUSCH transmission(s) in a 2-step/Type-2 RA procedure when a wireless device transmits/performs a plurality of PRACH transmissions (e.g., one or more repetitions of one or more RA preambles) using/with a plurality of spatial filters for a MsgA transmission.

According to example embodiments of the present disclosure, a wireless device may determine a first number of PRACH transmissions (e.g., the first number of repetitions of an RA preamble) for an RA procedure (of a cell). The wireless device may determine the first number of PUSCH transmission(s). The first number may be two. The wireless device may perform/transmit a first PRACH transmission using/with a first spatial filter. The wireless device may perform/transmit a second PRACH transmission using/with a second spatial filter. The wireless device may transmit a first PUSCH transmission using/with the first spatial filter, for example, based on performing/transmitting the first PRACH transmission using/with the first spatial filter. The wireless device may transmit a second PUSCH transmission using/with the second spatial filter, for example, based on performing/transmitting the second PRACH transmission using/with the second spatial filter. In another example, the wireless device may determine a first number of PRACH transmissions. The wireless device may determine a second number of PUSCH transmissions. The first number may be, for example, two. The second number may be, for example, one. The wireless device may perform/transmit a first PRACH transmission using/with a first spatial filter. The wireless device may perform/transmit a second PRACH transmission using/with a second spatial filter. The wireless device may determine a spatial filter, from/among the first spatial filter and the second spatial filter, to use for a PUSCH transmission. In an example, the wireless device may one or perform/transmit the PUSCH transmission using/with the first spatial filter, for example, based on the first spatial filter being associated with an RS selected for the RA procedure.

Based on using example embodiment(s) of the present disclosure, there may be a common understanding between a wireless device and a base station about the spatial filter(s) used for PUSCH transmission(s) in MsgA transmission(s). For example, based on receiving the plurality of PRACH transmissions (or the MsgA transmission(s) via one or more spatial domain reception/transmission filters, the base station may know the spatial domain reception/transmission filters to receive the PUSCH transmission(s) of the MsgA transmission(s), for example, without blind decoding (e.g., blind spatial decoding).

In an example embodiment according to the present disclosure, a wireless device may receive one or more configuration parameters of/for a cell. The wireless device may receive the one or more configuration parameters from a base station. The wireless device may determine to transmit/perform a plurality of PRACH transmissions (e.g., a plurality of repetitions of an RA preamble, a single repetition each of a plurality of RA preambles, one or more repetitions each of one or more RA preambles, and the like). The wireless device may determine to transmit/perform the plurality of PRACH transmissions, for example, for an RA procedure. The RA procedure may be, for example, a Type-2 (e.g., 2-step) RA procedure (e.g., as shown in FIG. 13C). The RA procedure may be performed in/for/via/on a cell.

The wireless device may perform/transmit MsgA transmission(s) for the RA procedure. The MsgA transmission(s) may comprise the plurality of PRACH transmissions. In an example, the plurality of PRACH transmissions may comprise a first number of PRACH transmissions (e.g., wherein the first number is greater than one).

The MsgA transmission(s) may comprise a second number of PUSCH transmission(s). In an example, the second number may be equal to one. In an example, the second number may be greater than one.

In an example, the one or more configuration parameters may indicate the first number. In an example, the one or more configuration parameters may indicate the second number. For example, the one or more configuration parameters may indicate a plurality of RSs. The wireless device may determine an RS, of/from the plurality of RSs, for the RA procedure. The wireless device may determine the first number, for example, based on (e.g., measuring) the RS. The wireless device may determine the second number, for example, based on (e.g., measuring) the RS.

In an example, the one or more configuration parameters may indicate threshold(s) (e.g., radio link quality threshold(s)). The wireless device may determine a radio link quality of the RS. The wireless device may compare the radio link quality against/with the threshold(s). In an example, the wireless device may determine the first number based on comparing the radio link quality against/with the threshold(s). In an example, the wireless device may determine the second number based on comparing the radio link quality against/with the threshold(s) (e.g., whether the radio link quality is greater than, equal to, or less than the threshold(s).

In an example, the first number and the second number may be the same. The wireless device may determine, for example, the first number and the second number to be the same. The wireless device may transmit/perform the first number of PRACH transmissions. The wireless device may transmit/perform the second number of PUSCH transmissions.

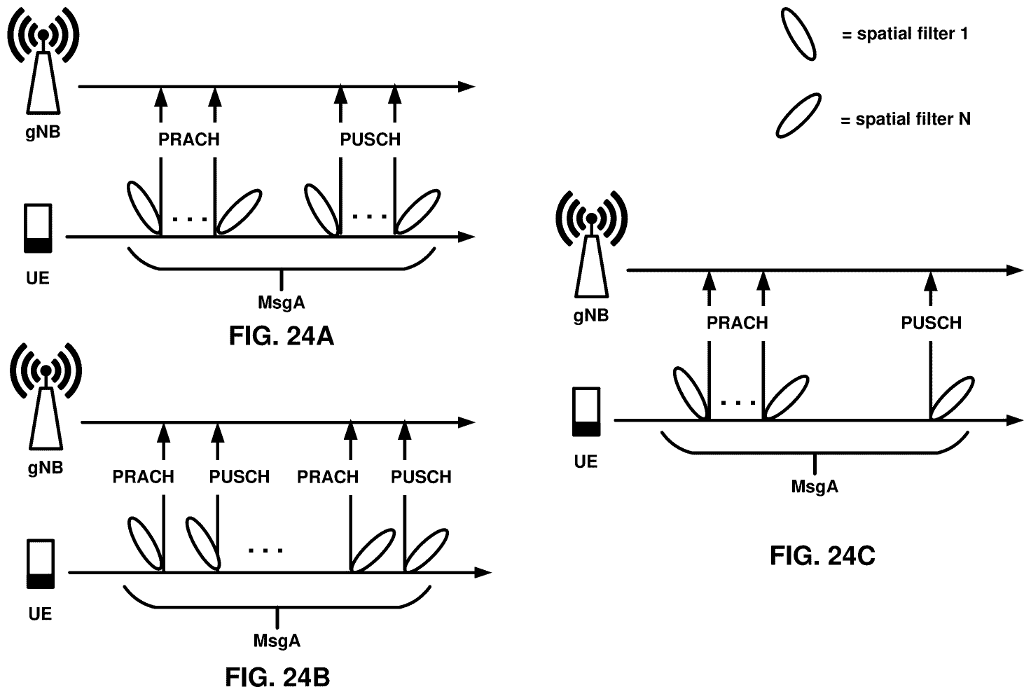

FIG. 24A shows an example timing diagram as per an aspect of an embodiment of the present disclosure. In the example of FIG. 24A, the first number may be the same as the second number. The wireless device may transmit/perform the first number of PRACH transmissions as shown in FIG. 24A. After completing (e.g., all/each PRACH transmission of) the first number of PRACH transmissions, the wireless device may transmit/perform the second number of PUSCH transmissions.

The wireless device may transmit/perform the first number of PRACH transmissions using/with/via a plurality of spatial filters. In an example, the first number may be two. The first number of PRACH transmissions may comprise a first PRACH transmission and a second PRACH transmission. The plurality of spatial filters may comprise a first spatial filter. The plurality of spatial filters may comprise a second spatial filter. The wireless device may perform/transmit the first PRACH transmission with/using/via the first spatial filter. The wireless device may transmit the second PRACH transmission with/using/via the second spatial filter.

The second number may be two. The second number of PUSCH transmissions may comprise a first PUSCH transmission. The second number of PUSCH transmissions may comprise a second PUSCH transmission. The second PUSCH transmission may, for example, be a repetition of the first PUSCH transmission. The PUSCH transmission may comprise a plurality of repetitions, for example, based on the second number being two.

The wireless device may perform/transmit the second number of PUSCH transmissions using/with/via the plurality of spatial filters, for example, based on transmitting the first number of PRACH transmissions using/with/via a plurality of spatial filters. The wireless device may transmit/perform the first PUSCH transmission (e.g., first PUSCH signal/message) using/with/via the first spatial filter, for example, based on performing/transmitting the first PRACH transmission with/using/via the first spatial filter. The wireless device may transmit/perform the second PUSCH transmission (e.g., second PUSCH signal/message) using/with/via the second spatial filter, for example, based on performing/transmitting the second PRACH transmission with/using/via the second spatial filter.

FIG. 24B shows an example timing diagram as per an aspect of an embodiment of the present disclosure. In the example of FIG. 24B, the first number may be the same as the second number. In an example, the first number may be two. The second number may be two. The wireless device may transmit/perform the first number of PRACH transmissions, e.g., using/with/via a plurality of spatial filters. The wireless device may transmit/perform the second number of PUSCH transmissions, e.g., using/with/via the plurality of spatial filters

The first number of PRACH transmissions may comprise a first PRACH transmission and a second PRACH transmission. The second number of PUSCH transmissions may comprise a first PUSCH transmission. The second number of PUSCH transmissions may comprise a second PUSCH transmission. The plurality of spatial filters may comprise a first spatial filter. The plurality of spatial filters may comprise a second spatial filter.

The wireless device may perform/transmit the first PRACH transmission with/using/via the first spatial filter. The wireless device may transmit, after the first PRACH transmission (e.g., and before the second PRACH transmission), the first PUSCH transmission with/using/via the first spatial filter, for example, based on performing/transmitting the first PRACH transmission with/using/via the first spatial filter. The first PRACH transmission may be a corresponding PRACH transmission of the first PUSCH transmission.

After performing/transmitting the first PRACH transmission and the first PUSCH transmission, as shown in FIG. 24B, the wireless device may perform/transmit the second PRACH transmission, for example, using the second spatial filter. The wireless device may transmit, after the second PRACH transmission, the second PUSCH transmission with/using/via the second spatial filter, for example, based on performing/transmitting the second PRACH transmission with/using/via the second spatial filter. The second PRACH transmission may be a corresponding PRACH transmission of the second PUSCH transmission.

FIG. 24C shows an example timing diagram as per an aspect of an embodiment of the present disclosure. In the example of FIG. 24B, the first number may be two. The second number may be one. The wireless device may transmit/perform a plurality (e.g., the first number) of PRACH transmissions using a plurality of spatial filters. The wireless device may transmit the second number (e.g., one) of PUSCH transmission(s). The wireless device may transmit the second number of PUSCH transmission(s), for example, using/with/via a spatial filter of the plurality of spatial filters.

In an example, the one or more configuration parameters may indicate the spatial filter of the plurality of spatial filters. For example, the one or more configuration parameters may comprise a field that indicates using a first/last spatial filter of the plurality of spatial filters. The wireless device may transmit the second number of PUSCH transmission(s) using/with/via the spatial filter, of the plurality of spatial filters, for example, based on the one or more configuration parameters indicating the spatial filter.

In an example, the wireless device may determine (e.g., select) a spatial filter from/among/of/out of the plurality of spatial filters. In an example, the first spatial filter may be associated with the RS (e.g., the RS determined (e.g., selected) for the RA procedure). For example, the wireless device may determine (e.g., calculate, compute, estimate, and the like) the first spatial filter from/using the RS, for example, based on using beam correspondence (e.g., beamcorrespondence-withoutULbeamSweeping). The wireless device may transmit/perform the second number of PUSCH transmission(s) using/with/via the first spatial filter, for example, based on the first spatial filter being associated with the RS.

In an example, the first spatial filter may be associated with a first index (e.g., beam index, RS index, SSB index, CSI-RS index and the like). The second spatial filter may be associated with a second index. The first index may be lower (e.g., less, smaller, below, weaker, poorer, and the like) than the second index. The wireless device may transmit/perform the second number of PUSCH transmission(s) using/with/via the first spatial filter, for example, based on the first spatial filter being associated with the first index that is lower than the second index (or the lowest among a plurality of indexes, wherein the each index of the plurality of indexes are associated with a respective spatial filter of the plurality of spatial filters). In an example, the wireless device may transmit/perform the second number of PUSCH transmission(s) using/with/via the second spatial filter, for example, based on the second spatial filter being associated with the second index that is higher than the first index (or the highest/greatest among a plurality of indexes, wherein the each index of the plurality of indexes are associated with a respective spatial filter of the plurality of spatial filters).

In this specification, example embodiments (e.g., methods, procedures, and the like) described for PRACH and PUSCH may be interchangeable. Example embodiments described for PRACH/PUSCH may (also) be applicable to other channels, e.g., PUCCH, SRS, PRS, PSCCH, PSSCH, PSFCH and the like.

In some embodiments, transmitting an UL signal/message may be equivalent to/same as performing an (or a corresponding) UL transmission (e.g., UL transmission of the UL signal/message). For example, transmitting a UL signal/message may be the same as/comprise performing the UL transmission (e.g., of the UL signal/message). For example, performing a PRACH transmission may be the same as/comprise transmitting an RA preamble (e.g., the PRACH transmission). Transmitting and performing a transmission may be, for example, identical (equivalent, or same as each other).

In some embodiments, an RA preamble may refer to (e.g., mean, comprise, be, and the like) an uplink signal/message (e.g., PRACH transmission/message, RACH transmission/message, Msg1, Msg3, Msg5, Msg4 HARQ-ACK, PUCCH transmission/message, PUSCH transmission/message, RA preamble).

In some embodiments, an RA procedure may be performed for a purpose (e.g., raPurpose). Based on the purpose of the RA procedure, a wireless device may determine (e.g., set, use, configure, and the like) a parameter (e.g., raPurpose) to a value corresponding to the purpose. In an example, the purpose may be initial access for the wireless device from RRC_IDLE/RRC_INACTIVE mode/state. In an example, the purpose may be RRC connection reestablishment. In an example, the purpose may be downlink or uplink data arrival during RRC_CONNECTED and/or RRC_INACTIVE when the uplink synchronization status is “non-synchronized.” In an example, the purpose may be uplink data arrival when there are no PUCCH resources for SR available to the wireless device. In an example, the purpose may be SR failure. In an example, the purpose may be request by a RRC layer of the wireless device upon synchronous reconfiguration (e.g., handover). In an example, the purpose may be RRC connection resume procedure from RRC_INACTIVE/RRC_IDLE state/mode. In an example, the purpose may be to establish time alignment for a secondary timing advance group. In an example, the purpose may be to request for other system information. In an example, the purpose may be for beam failure recovery. In an example, the purpose may be due to consistent uplink listen before talk (LBT) failure on a SpCell. In an example, the purpose may be for SDT in RRC_INACTIVE/RRC_IDLE mode/state. In an example, the purpose may be for positioning during RRC_CONNECTED state requiring the RA procedure, e.g., when timing advance is needed for positioning.

In an example, the RA procedure may be a 4-step (e.g., type-1) RA procedure. In an example, the RA procedure may be a 2-ste (e.g., type-2) RA procedure. In an example, the RA procedure may be a contention based RA (CBRA) procedure. The wireless device may select/transmit an RA preamble from a set of RA preambles dedicated to CBRA, for example, based on the RA procedure being a CBRA.

In an example, the RA procedure may be a contention free RA (CFRA) procedure. The wireless device may select/transmit an RA preamble from a set of preambles dedicated to CFRA, for example, based on the RA procedure being a CFRA.

In some embodiments, a number of repetitions (e.g., a number of repetitions of an RA preamble, a number of PRACH transmissions, a plurality of PRACH transmissions, and the like) and a (associated) level (or a level and an associated number of repetitions, e.g., coverage enhancement (CE) level, CE mode, and the like) may be used interchangeably (or may mean the same, or indicate the same). For example, a first level may be associated with a first number of repetitions of an RA preamble (e.g., a first plurality of PRACH transmissions) and a second level may be associated with a second number of repetitions of the RA preamble (e.g., a second plurality of PRACH transmissions). The wireless device may determine, for example, a level (of the wireless device) to be the first level. Determining the level to be the first level may, for example, be the same as determining the number of repetitions to be the first number of repetitions. The wireless device may determine, for example, a number of repetitions to be the second number of repetitions. Determining the number of repetitions to be the second number of repetitions may, for example, be the same as determining a level to be the second level. In an example, the first number of repetitions and the second number of repetitions may be the same. The first level and the second level may be the same, for example, based on the first number of repetitions and the second number of repetitions being the same. In an example, the wireless device may determine that the first number of repetitions and the second number of repetitions are the same. The wireless device may determine that the first level and the second level are the same, for example, based on the first number of repetitions and the second number of repetitions being the same. In an example, the first number of repetitions may be associated with a first value. The first level may be associated with the first value, for example, based on the first number of repetitions being associated with the first value.

In an example, a first number of repetitions may be associated with a first level. The wireless device may transmit the first number of repetitions of an RA preamble (e.g., a first number/plurality of PRACH transmissions), for example, based on determining a level of the wireless device to be the first level. In an example, a second number of repetitions may be associated with a second level. The wireless device may transmit the second number of repetitions of an RA preamble (e.g., a second number/plurality of PRACH transmissions), for example, based on determining the level of the wireless device to be the second level.

In an example, transmitting a number of repetitions of an RA preamble may comprise transmitting the (same) preamble the number of times. In an example, the number of repetitions may be one. The wireless device may transmit the preamble once, for example, based on the number of repetitions being one. In an example, the number of repetitions being one may be considered to be preamble without repetitions. In another example, the number of repetitions may be two. The wireless device may transmit the preamble. The wireless device may subsequently transmit the same preamble again for a total of two times, for example, based on the number of repetitions being two.

In an example, a number of repetitions (e.g., of an RA preamble) may be higher than one. The wireless device may transmit a plurality of repetitions of the RA preamble. Transmitting a plurality of repetitions of the RA preamble (or transmitting a number of repetitions of the RA preamble, wherein the number of repetitions is higher than one) may be referred to, for example, as multiple preamble transmission, multiple Msg1 transmission, multiple PRACH transmission, multiple RACH transmission, multi-Msg1 repetition, multi-Msg1 transmission, random access message repetition, multiple random access message transmission, and the like. Transmitting one repetition of the RA preamble may also be referred to as transmitting the RA preamble with no repetitions (or without repetitions).

In an example, an nth preamble, x_{u,v}(n), may be generated by the wireless device according to

$${x}_{u , v} ( n ) = {x}_{u} ( ( n + {C}_{v} ) mod {L}_{RA} )$$

$${x}_{u} ( i ) = {e}^{- j \frac{π u i ( i + 1 )}{{L}_{RA}}} , i = 0 , 1 , … , {L}_{RA} - 1$$

from which the frequency-domain representation is generated according to

$${y}_{u , v} ( n ) = {\sum }_{m = 0}^{{L}_{RA} - 1} {x}_{u , v} ( m ) \cdot {e}^{- j \frac{2 π m n}{{L}_{RA}}}$$

where L_{RA}=839, L_{RA}=139, L_{RA}=1151, or L_{RA}=571 depending on the PRACH preamble format. There may be, for example, 64 preambles defined in each time-frequency PRACH occasion, enumerated in increasing order of first increasing cyclic shift Cy of a logical root sequence, and then in increasing order of the logical root sequence index, starting with the index obtained from the higher-layer parameter prach-RootSequenceIndex or rootSequenceIndex-BFR or by msgA-PRACH-RootSequenceIndex if configured and a type-2 random access procedure is initiated. Additional preamble sequences, in case 64 preambles may not be generated from a single root Zadoff-Chu sequence, may be obtained from the root sequences with the consecutive logical indexes until all the 64 sequences are found. The logical root sequence order may be cyclic; the logical index 0 may be consecutive to L_{RA}−2. The sequence number u may be obtained from a logical root sequence index according to preconfigured table(s).

In an example, the wireless device may transmit a number of repetitions of an RA preamble. The number of repetitions may be higher than one. Each repetition of the RA preamble of the number of repetitions of the RA preamble may comprise a second number of repetitions of a sequence. In an example, the sequence may be a Zadoff-Chu sequence, logical root sequence, root sequence, and the like. The number of repetitions of the RA preamble may comprise transmitting the number of repetitions of a second number of repetitions of the sequence. For example, the number of repetitions may be two. The second number of repetitions may be four. Transmitting the number of repetitions of the RA preamble may comprise transmitting eight repetitions of the sequence. The number of repetitions of the RA preamble and the second number of repetitions of the sequence may, for example, be the same. The number of repetitions of the RA preamble and the second number of repetitions of the sequence may, for example, be different. In an example, the number of repetitions of the RA preamble may be one. The second number of repetitions of the sequence may be four. Transmitting the number of repetitions (e.g., one, no repetitions, and the like) of the RA preamble may comprise transmitting the sequence four times, for example, based on the second number of repetitions being four.

In an example, the wireless device may determine a number of repetitions of an RA preamble. Determining a number of repetitions of a RA preamble may comprise determining to transmit the number of repetitions of the RA preamble. In an example, the wireless device may determine one or more RA resources (e.g., based on a determined RS). Determining the one or more RA resources may comprise determining to transmit an uplink signal (e.g., PRACH signal, RACH signal, preamble, Msg1, Msg3, PUSCH, PUCCH, and the like) over/using/via the one or more RA resources. In an example, the wireless device may determine an RA preamble based on an RS. Determining the RA preamble may comprise determining to transmit the preamble.

In some embodiments, determining an RS (e.g., for a RA procedure) may comprise selecting the RS (e.g., for the RA procedure). Determining an RS may comprise choosing the RS. Determining the RS may comprise picking the RS. Determining the RS may comprise using the RS.

In some embodiments, determining an RS may comprise determining an RS for an RA procedure. Based on determining an RS for the RA procedure, a wireless device may determine RA resource(s) based on the RS. The wireless device may transmit one or more repetitions of an RA preamble via/using the RA resource(s). The wireless device may determine a number of repetitions of an RA preamble based on a radio link quality of the RS. The wireless device may transmit the number of repetitions of the RA preamble, for the RA procedure (of/for/in/via a cell), via/over/using the RA resource(s), for example, based on determining the RS.

In some embodiments, determining an RS may comprise determining one or more (RA) resources, based on the RS, for transmitting an uplink signal (e.g., RA preamble, PUSCH, PUCCH, SRS, and the like), e.g., for a RA procedure. Determining a number of repetitions may comprise transmitting the number of repetitions of the uplink signal via/over/using the one or more RA resources.

In some embodiments, a spatial filter may comprise/be/mean spatial domain transmit filter, spatial domain transmitting filter, beam, TX beam, precoder, transmission configuration indicator/indication (TCI) state, QCL assumption/relation/information, DMRS port, precoding matrix, beamforming matrix, beamformer, and/or the like.

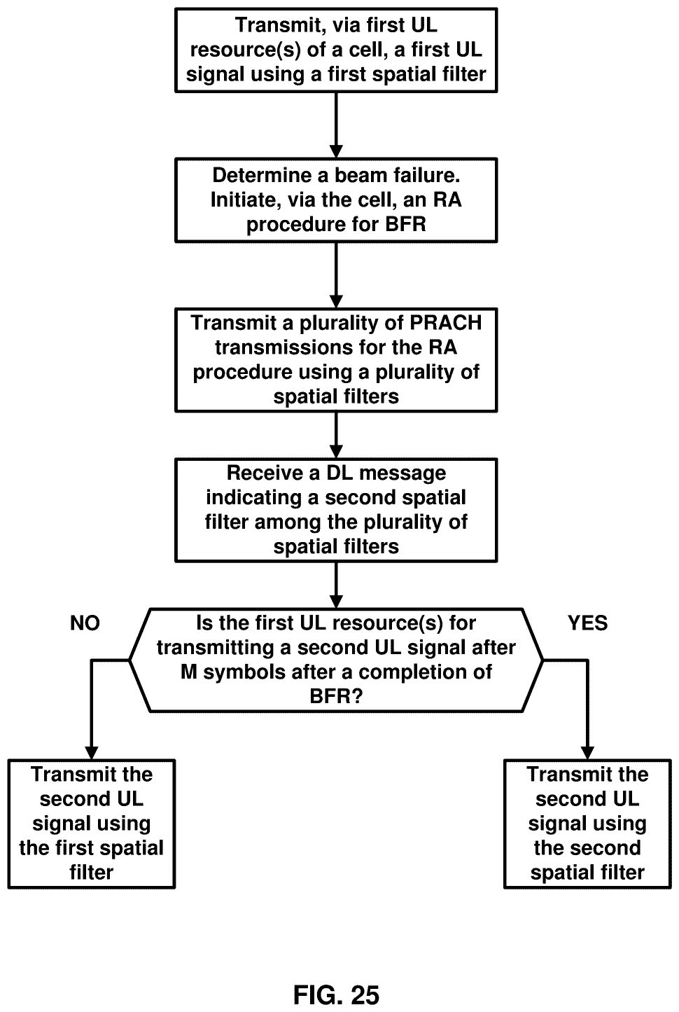

FIG. 25 shows an example flow diagram as per an aspect of an embodiment of the present disclosure. According to the example of FIG. 25, a wireless device may transmit a first UL signal/message. The wireless device may transmit the first UL signal/message (e.g., PUSCH, PUCCH, SRS, and the like), for example, via/using/over/on first UL resource(s) of a cell. The wireless device may transmit the first UL signal/message, for example, via/using/with a first spatial filter.

The wireless device may determine a beam failure (e.g., in/on/of/for the cell). The wireless device may trigger/initiate a BFR (e.g., in/on/of/for the cell). The wireless device may initiate/perform an RA procedure (e.g., in/on/of/for the cell), for example, for the BFR. The wireless device may transmit/perform a plurality of PRACH transmissions (e.g., a plurality of same RA preambles, a plurality of different RA preambles, one or more repetitions (each) of one or more RA preambles, and the like) for the RA procedure. The wireless device may transmit/perform the plurality of PRACH transmissions, for example, via/using/with a plurality of spatial filters.

The wireless device may receive a DL message, for example, in response to (or based on) transmitting/performing the plurality of PRACH transmissions. The DL message may indicate, for example, a second spatial filter from/among/amongst/of/out of the plurality of spatial filters.

In an example, the wireless device may determine first UL resource(s) (e.g., PUCCH resource(s), PUSCH resource(s), SRS resource(s), and the like) for transmitting a second UL signal/message (e.g., PUCCH, PUSCH, SRS). For example, the one or more configuration parameters may indicate the first UL resource(s).

In an example, the first UL resource(s) may be before M (where M=7, 14, 28, 35, 42, and the like) symbols after a completion of the BFR. The wireless device may transmit the second UL signal/message using the first spatial filter (e.g., not using the second spatial filter), for example, based on the first UL resource(s) being before M symbols after the completion of the BFR. The wireless device may not use the second spatial filter to transmit the second UL message/signal, for example, based on the first UL resource(s) being before M symbols after the completion of the BFR. The wireless device may transmit the second UL signal/message using the first spatial filter (e.g., not using the second spatial filter), for example, based on transmitting the second UL signal/message before M symbols after the completion of the BFR. The wireless device may not use the second spatial filter to transmit the second UL signal/message, for example, based on transmitting the second UL signal/message before M symbols after the completion of the BFR.

In an example, the first UL resource(s) may be after M (where M=7, 14, 28, 35, 42, and the like) symbols after the completion of the BFR. The wireless device may transmit the second UL signal/message using the second spatial filter (e.g., that is indicated in the DL message), for example, based on the first UL resource(s) being after M symbols after the completion of the BFR. The wireless device may transmit the second UL signal/message using the second spatial filter (e.g., that is indicated in/by the DL message), for example, based on transmitting the second UL signal/message after M symbols after the completion of the BFR.

An example method comprising: transmitting, by a wireless device and via a physical uplink control channel (PUCCH) resource of a cell, a first uplink (UL) signal with a first spatial filter; transmitting, with a plurality of spatial filters, a random access (RA) preamble for a beam failure recovery (BFR) of the cell; receiving a downlink (DL) message corresponding to the RA preamble, wherein the DL message indicates a second spatial filter of the plurality of spatial filters; and based on the PUCCH resource being after a number of symbols after a completion of the BFR, transmitting, via the PUCCH resource, a second UL signal with the second spatial filter indicated by the DL message.

The above example method, further comprising transmitting a third UL signal via the PUCCH resource with the first spatial filter before the number of symbols after the completion.

One or more of the above example methods, further comprising transmitting, after receiving the DL message and before the completion of the BFR, a fourth UL signal via the PUCCH resource with the first spatial filter.

One or more of the above example methods, wherein each RA preamble of the one or more RA preambles is associated with a same RA procedure.

One or more of the above example methods, wherein the RA procedure is initiated by the wireless device for the BFR.

One or more of the above example methods, wherein the RA procedure is initiated based on a beam failure instance counter being greater than or equal to a configured threshold.

One or more of the above example methods, wherein transmitting the RA preamble comprises performing a plurality of physical random access channel (PRACH) transmissions.

One or more of the above example methods, further comprising setting a preamble transmission counter to a first value.

One or more of the above example methods, wherein each PRACH transmission of the plurality of PRACH transmissions is associated with the preamble transmission counter being set to the first value.

One or more of the above example methods, wherein the first UL signal is a first physical uplink control channel (PUCCH) message.

One or more of the above example methods, wherein the second UL signal is a second physical uplink control channel (PUCCH) message.

One or more of the above example methods, wherein number of symbols is 28 symbols.

One or more of the above example methods, wherein the plurality of spatial filters does not comprise the first spatial filter.

One or more of the above example methods, wherein the plurality of spatial filters comprises the first spatial filter.

One or more of the above example methods, wherein the DL message is at least one of Msg2, RAR, PDCCH, DCI, Msg3, and/or PDSCH comprising a contention resolution identity of the wireless device.

One or more of the above example methods, wherein the DL message indicates the second spatial filter based on indicating at least one of: an RA preamble index, an RA-RNTI, an RA resource.

An example method comprising: transmitting, by a wireless device and with a plurality of spatial filters, a random access (RA) preamble for a beam failure recovery (BFR) of a cell; receiving a downlink message corresponding to the RA preamble, wherein the downlink message indicates a first spatial filter of the plurality of spatial filters; and a number of symbols after a completion of the BFR, transmitting uplink signals with the first spatial filter indicated by the downlink message.

A method comprising: receiving, by a base station and via an uplink resource of a cell, a first uplink signal with a first spatial filter; receiving, with a plurality of spatial filters, a random access (RA) preamble for a beam failure recovery (BFR) of the cell; transmitting a downlink message corresponding to the RA preamble, wherein the downlink message indicates a second spatial filter of the plurality of spatial filters; and a number of symbols after a completion of the BFR, receiving, via the uplink resource, a second uplink signal with the second spatial filter indicated by the downlink message.

A method comprising: receiving, by a wireless device, configuration parameters indicating random access (RA) resources for an RA procedure; transmitting a plurality of physical random access channel (PRACH) transmissions/messages for the RA procedure using a plurality of spatial filters; and transmitting, after the plurality of PRACH transmissions, a plurality of uplink signals for the type-2 RA procedure using the plurality of spatial filters, wherein each uplink signal of the plurality of uplink signals is transmitted using a respective spatial filter of the plurality of spatial filters.

A method comprising: transmitting, a plurality of RA preambles via a plurality of RA resources, wherein each RA resource of the plurality of RA resources is associated with a respective RB set of a plurality of RB sets; receiving a downlink message corresponding to the one or more RA preambles, wherein the downlink message indicates a first RB set of the plurality of RB sets; and transmitting an uplink signal based on the first RB set.

A method comprising: receiving, by a wireless device, configuration parameters indicating random access (RA) preambles and uplink (UL) resource block (RB) sets, wherein each RA preamble of the RA preambles is associated with a respective UL RB set of the UL RB sets; transmitting one or more repetitions of a plurality of RA preambles, of the RA preambles, wherein each RA preamble of the plurality of RA preambles is associated with a first UL RB set of the UL RB sets.

Clause 1. A method comprising: transmitting, by a wireless device and via a physical uplink control channel (PUCCH) resource of a cell, a first uplink signal with a first spatial filter; transmitting, for a beam failure recovery (BFR) of the cell, a random access (RA) preamble with a plurality of spatial filters; receiving a message corresponding to the RA preamble, wherein the message indicates a second spatial filter of the plurality of spatial filters; and transmitting, after a number of symbols from completion of the BFR and via the PUCCH resource of the cell, a second uplink signal with the second spatial filter indicated by the message.

Clause 2. A method comprising: transmitting, by a wireless device and for a beam failure recovery (BFR) of a cell, a random access preamble with a plurality of spatial filters; receiving a message corresponding to the random access preamble, wherein the message indicates a spatial filter of the plurality of spatial filters; and transmitting, after a number of symbols from completion of the BFR, an uplink signal with the spatial filter indicated by the message.

Clause 3. The method of clause 2, wherein the uplink signal is transmitted via an uplink resource of a cell.

Clause 4. The method of clause 3, wherein the uplink resource is at least one of: a physical uplink control channel (PUCCH) resource; a physical uplink shared channel (PUSCH) resource; and a sounding reference signal (SRS) resource.

Clause 5. The method of clause 3, further comprising transmitting, by the wireless device, a first uplink signal with a first spatial filter.

Clause 6. The method of clause 5, wherein the first uplink signal is transmitted via a first uplink resource of the cell.

Clause 7. The method of clause 6, wherein the first uplink resource is at least one of: a physical uplink control channel (PUCCH) signal; a physical uplink shared channel (PUSCH) signal; and a sounding reference signal (SRS) signal.

Clause 8. The method of any one of clauses 6 and 7, further comprising transmitting, by the wireless device, a second uplink signal via the first uplink resource with the first spatial filter until the number of symbols after the completion of the BFR.

Clause 9. The method of clause 8, further comprising transmitting, by the wireless device, after receiving the message and before the completion of the BFR, a third uplink signal via the first uplink resource with the first spatial filter.

Clause 10. The method of any one of clauses 5 to 9, wherein the plurality of spatial filters does not comprise the first spatial filter.

Clause 11. The method of any one of clauses 5 to 9, wherein the plurality of spatial filters comprises the first spatial filter.

Clause 12. The method of any one of clauses 2 to 11, wherein transmitting the random access preamble is for a random access procedure initiated by the wireless device for the BFR.

Clause 13. The method of clause 12, wherein the random access procedure is initiated based on a beam failure instance counter being greater than or equal to a configured threshold.

Clause 14. The method of any one of clauses 2 to 13, wherein transmitting the random access preamble comprises performing a plurality of physical random access channel (PRACH) transmissions.

Clause 15. The method of any one of clauses 2 to 14, further comprising setting a preamble transmission counter to a first value.

Clause 16. The method of any one of clauses 2 to 15, wherein the number of symbols is 28 symbols.

Clause 17. The method of any one of clauses 2 to 16, wherein the message comprises at least one of: a Msg2; a ransom access (RA) response; a physical downlink control channel (PDCCH); downlink control information (DCI); a Msg4; and a physical data downlink shared channel (PDSCH), wherein the PDSCH comprises a contention resolution identity of the wireless device.

Clause 18. The method of any one of clauses 2 to 17, wherein the message indicates the spatial filter of the plurality of spatial filters is based on at least one of: a preamble index; a RA-radio network temporary identifier; and a random access resource.

Clause 19. A method comprising: transmitting, by a wireless device, a random access preamble via a plurality of random access resources, wherein each random access resource, of the plurality of random access resources, is associated with a respective resource block set, of a plurality of resource block sets; receiving a random access response, corresponding to the random access preamble, indicating a resource block set of the plurality of resource block sets; and transmitting, via a physical uplink shared channel (PUSCH), a random access message using the resource block set.

Clause 20. A method comprising: transmitting, by a wireless device, a random access preamble using a plurality of resource block sets; and receiving a random access response corresponding to the random access preamble indicating a resource block set among the plurality of resource block sets.

Clause 21. The method of clause 20, wherein each random access resource, of a plurality of random access resources, is associated with a respective resource block set, of the plurality of resource block sets.

Clause 22. The method of clauses 20 and 21, further comprising transmitting, by the wireless device, via a physical uplink shared channel (PUSCH), a random access message using the resource block set.

Clause 23. The method of clause 22, wherein transmitting the random access message using the resource block set further comprises performing a listen-before-talk procedure associated with the resource block set.

Clause 24. The method of any one of clauses 21 to 23, wherein the plurality of random access resources are one of: a plurality of random access channel (RACH) occasions (ROs); a plurality of slots; or a plurality of resource blocks.

Clause 25. The method of any one of clauses 21 to 24, wherein each random access resource, of the plurality of random access resources, is associated with a respective resource block set based on the respective resource block set comprising each random access resource.

Clause 26. The method of any one of clauses 20 to 25, wherein the random access response indicates the resource block set based on indicating a random access preamble index.

Clause 27. The method of any one of clauses 20 to 26, wherein the random access response indicates the resource block set based on indicating a random access radio network temporary identifier.

Clause 28. The method of any one of clauses 20 to 27, wherein the random access response indicates the resource block set based on indicating an index of a random access channel (RACH) occasion (RO).

Clause 29. The method of clause 28, wherein the resource block set comprises the RO.

Clause 30. The method of any one of clauses 20 to 29, further comprising receiving one or more random access responses, wherein the random access response is last among the one or more random access responses.

Clause 31. The method of any one of clauses 20 to 30, further comprising determining, by the wireless device, a second resource block set among the plurality of resource block sets.

Clause 32. The method of clause 31, wherein determining the second resource block set is based on transmitting a first repetition of the random access preamble via a random access resource associated with the second resource block set.

Clause 33. The method of clause 31, wherein determining the second resource block set is based on transmitting a last repetition of the random access preamble via a random access resource associated with the second resource block set.

Clause 34. The method of clause 31, wherein determining the second resource block set is based on transmitting the random access preamble via a random access resource, associated with the second resource block set, without a listen-before-talk failure.

Clause 35. The method of clause 31, wherein determining the second resource block set is based on the second resource block set being associated with a lowest index among a plurality of resource block set indexes.

Clause 36. The method of clause 31, wherein determining the second resource block set is based on the second resource block set being associated with a highest index among a plurality of resource block set indexes.

Clause 37. The method of clause 36, wherein each resource block set index, of the plurality of resource block set indexes, is associated with a respective resource block set among the plurality of resource block sets.

Clause 38. The method of clause 31, wherein determining the second resource block set is based on the second resource block set being associated with a lowest frequency among the plurality of resource block sets.

Clause 39. The method of clause 31, wherein determining the second resource block set is based on the second resource block set being associated with a highest frequency among the plurality of resource block sets.

Clause 40. A method comprising: transmitting, by a wireless device and for a random access procedure, a plurality of repetitions of a random access preamble with a plurality of spatial filters, wherein each repetition of the plurality of repetitions of the random access preamble is transmitted with a respective spatial filter of the plurality of spatial filters; transmitting, for the random access procedure, a plurality of repetitions of a physical uplink shared channel (PUSCH) signal using the plurality of spatial filters, wherein each repetition of the plurality of repetitions, of the PUSCH signal is transmitted with a respective spatial filter of the plurality of spatial filters.

Clause 41. The method of clause 40, wherein a random access message comprises the random access preamble and the PUSCH signal.

Clause 42. The method of clause 41, wherein the random access message is a Message A.

Clause 43. The method of clause 41, wherein the random access procedure is a two-step random access procedure.

Clause 44. The method of clause 41, wherein the random access procedure is a type-2 random access procedure.

Clause 45. The method of any one of clauses 40 to 44, further comprising determining the plurality of repetitions of the PUSCH signal based on the plurality of repetitions of a random access preamble.

Clause 46. An apparatus comprising one or more processors and memory storing instructions that, when executed by the one or more processors, cause the apparatus at least to perform the method according to any one of clauses 1 to 45.

Clause 47. A non-transitory computer-readable medium comprising instructions that, when executed by one or more processors of a device, cause the device to perform the method according to any one of clauses 1 to 45.

Clause 48. An apparatus comprising means for performing the method according to any one of clauses 1 to 45.

Clause 49. An apparatus comprising circuitry configured to perform the method according to any one of clauses 1 to 45.

Clause 50. A computer program product encoding instructions for performing the method according to any one of clauses 1 to 45.

What is claimed is:

1. A method comprising:
transmitting, by a wireless device and for a beam failure recovery (BFR) of a cell, a random access preamble with a plurality of spatial filters;
receiving a message corresponding to the random access preamble, wherein the message indicates a spatial filter of the plurality of spatial filters; and
transmitting, after a number of symbols from completion of the BFR, an uplink signal with the spatial filter indicated by the message.

2. The method of claim 1, wherein the uplink signal is transmitted via an uplink resource of a cell.

3. The method of claim 2, wherein the uplink resource is at least one of:
a physical uplink control channel (PUCCH) resource;
a physical uplink shared channel (PUSCH) resource; and
a sounding reference signal (SRS) resource.

4. The method of claim 2, further comprising transmitting, by the wireless device, a first uplink signal with a first spatial filter.

5. The method of claim 4, wherein the first uplink signal is transmitted via a first uplink resource of the cell.

6. The method of claim 5, wherein the first uplink resource is at least one of:
a physical uplink control channel (PUCCH) signal;
a physical uplink shared channel (PUSCH) signal; and
a sounding reference signal (SRS) signal.

7. The method of claim 5, further comprising transmitting, by the wireless device, a second uplink signal via the first uplink resource with the first spatial filter until the number of symbols after the completion of the BFR.

8. The method of claim 7, further comprising transmitting, by the wireless device, after receiving the message and before the completion of the BFR, a third uplink signal via the first uplink resource with the first spatial filter.

9. The method of claim 1, wherein transmitting the random access preamble is for a random access procedure initiated by the wireless device for the BFR.

10. A wireless device comprising:
one or more processors; and
memory storing instructions that, when executed by the one or more processors, cause the wireless device to:
transmit, for a beam failure recovery (BFR) of a cell, a random access preamble with a plurality of spatial filters;
receive a message corresponding to the random access preamble, wherein the message indicates a spatial filter of the plurality of spatial filters; and
transmit, after a number of symbols from completion of the BFR, an uplink signal with the spatial filter indicated by the message.

11. The wireless device of claim 10, wherein the uplink signal is transmitted via an uplink resource of a cell.

12. The wireless device of claim 11, wherein the uplink resource is at least one of:
a physical uplink control channel (PUCCH) resource;
a physical uplink shared channel (PUSCH) resource; and
a sounding reference signal (SRS) resource.

13. The wireless device of claim 11, wherein the instructions further cause the wireless device to transmit a first uplink signal with a first spatial filter.

14. The wireless device of claim 13, wherein the first uplink signal is transmitted via a first uplink resource of the cell.

15. The wireless device of claim 14, wherein the first uplink resource is at least one of:
a physical uplink control channel (PUCCH) signal;
a physical uplink shared channel (PUSCH) signal; and
a sounding reference signal (SRS) signal.

16. The wireless device of claim 14, wherein the instructions further cause the wireless device to transmit a second uplink signal via the first uplink resource with the first spatial filter until the number of symbols after the completion of the BFR.

17. The wireless device of claim 16, further comprising transmitting, by the wireless device, after receiving the message and before the completion of the BFR, a third uplink signal via the first uplink resource with the first spatial filter.

18. A wireless device comprising:
one or more processors; and
memory storing instructions that, when executed by the one or more processors, cause the wireless device to:
receive configuration parameters of a serving cell of the wireless device, wherein the configuration parameters indicate:
a plurality of reference signals (RSs), wherein the plurality of RSs comprise a synchronization signal block (SSB); and
a reference signal received power (RSRP) threshold;
determine, for a random-access procedure:
the SSB, of the plurality of RSs, based on an RSRP of the SSB being above the RSRP threshold;
a number of preamble repetitions based on the RSRP; and
random-access resources associated with the SSB;
transmit, using a first spatial filter and via the random-access resources, the number of preamble repetitions of a physical random-access channel (PRACH) transmission;
receive a downlink message, on a physical downlink control channel (PDCCH), indicating a completion of the random-access procedure; and
transmit, after a first predetermined number of symbols from receiving the downlink message on the PDCCH, an uplink signal:
using the first spatial filter; and
via a physical uplink control channel (PUCCH).

19. The wireless device of claim 18, wherein the first predetermined number of symbols is twenty-eight symbols.

20. The wireless device of claim 18, wherein the configuration parameters are received in one or more radio resource control (RRC) messages.
